(19) United States
(12) Patent Application Publication
(10) Pub. No.: US 2026/0318174 A1
(43) Pub. Date: Oct. 15, 2026

(54) METHOD OF HYDROGEN STORAGE AND WITHDRAWAL

(71) Applicant: King Fahd University of Petroleum and Minerals, Dhahran (SA)

(72) Inventors: Md Bashirul HAQ, Dhahran (SA); Dhafer Abdullah AL SHEHRI, Dhahran (SA); Nasiru Salahu MUHAMMED, Dhahran (SA)

(73) Assignee: King Fahd University of Petroleum and Minerals, Dhahran (SA)

(21) Appl. No.: 19/179,901

(22) Filed: Apr. 15, 2025

(51) Int. Cl. E21B 41/00; C01B 3/0018; E21B 43/16; F17C 1/00

(52) U.S. Cl. CPC E21B 41/0057; C01B 3/0018; E21B 43/168; F17C 1/007; F17C 2221/012; F17C 2270/0152

(57) ABSTRACT

A method of hydrogen (H₂) storage and withdrawal includes executing a first cycle of low-speed storage and withdrawal and executing a second cycle of high-speed storage and withdrawal. The first cycle includes injecting a first cushion gas, a first working gas and a first brine solution into a subsurface formation. The second cycle includes injecting a second cushion gas, a second working gas and a second brine solution into the subsurface formation. The first cushion gas, including 30-50 vol. % of CH₄ and 50-70 vol. % of H₂ based on a total volume of the first cushion gas, is injected at a speed of 0.2-0.6 cc/min/225 g sandstone rock. The second cushion gas, including 30-50 vol. % of CO₂ and 50-70 vol. % of H₂ based on a total volume of the second cushion gas, is injected at a speed of 1.2-10 cc/min/225 g sandstone rock.

### STATEMENT REGARDING PRIOR DISCLOSURE BY THE INVENTORS

Aspects of the present disclosure are described in “Hydrogen injection and withdrawal performance in depleted gas reservoirs” International Journal of Hydrogen Energy, 96 (2024), 427-442, which is incorporated herein by reference in its entirety.

### BACKGROUND

### Technical Field

The present disclosure is directed to a method of hydrogen (H₂) storage and recovery.

### Description of Related Art

The “background” description provided herein presents the context of the disclosure generally. The work of the presently named inventors, to the extent it is described in this background section, as well as aspects of the description that may not otherwise qualify as prior art at the time of filing, are neither expressly nor impliedly admitted as prior art against the present invention.

Several mechanisms play important roles in the containment and retention of gases (such as methane (CH₄), carbon dioxide (CO₂), and hydrogen (H₂)) within geological formations. For example, structural trapping involves the physical confinement of gases within porous rock formations by impermeable caprocks or structural features, preventing their upward migration. Residual trapping occurs as a result of capillary forces, where a portion of injected gases remains immobile within pore spaces after injection. Dissolution trapping refers to the dissolution of gases into pore fluids, such as brine or water, where they remain dissolved due to their solubility in the fluid phase. Mineralization trapping involves the chemical reaction between gases and the formation minerals, leading to the formation of solid mineral compounds over time, which effectively immobilizes the gases within the reservoir.

Structural trapping may face limitations due to the uneven distribution of geological features required for such trapping across storage formations. In carbon capture and storage (CCS), the integration of mineralization and dissolution trapping mechanisms is highly desirable, despite the comparatively slower kinetics of such processes, when compared to underground gas storage (UGS) for CH₄ and H₂ storage in underground hydrogen storage (UHS), which necessitates temporal storage. Therefore, residual trapping is important for the short to medium-term storage success of CH₄ and H₂.

UGS and UHS share operational similarities, involving cyclic compressed gas storage and initial cushion gas injection. However, insights from CCS and UGS (such as site suitability, production history, drive mechanisms, and reservoir performance) inform H₂ behavior predictions in UHS. Yet, UHS differs from UGS and CCS due to significant physicochemical and characteristic variations (such as molecular weight, diffusivity, dissolution, density, viscosity, and interfacial tension) among H₂, CH₄, and CO₂.

In CCS, residual trapping occurs at the rear part of the CO₂ plume when water imbibes the pore space, causing CO₂ to form isolated droplets (ganglia), which plays a role in overall storage efficiency. Studies indicate that higher initial CO₂ saturation leads to increased residual CO₂ saturation, driven by a larger non-wetting phase that aids in immobilization through snap-off mechanisms, which are influenced by CO₂/brine/rock wettability. Additionally, water-wet and oil-wet systems have comparable initial saturation, but residual CO₂ saturation is nearly halved in oil-wet systems due to factors such as organic contaminants, prolonged CO₂ exposure, and subsurface microbial presence.

Various factors affect the trapping process, including: (i) inherent rock characteristics, such as pore network geometry, rock type, and pore aspect ratio, (ii) CO₂/brine/rock properties such as wettability and interfacial tension, (iii) operating conditions, including injection rates, strategy, and the type of imbibing water, and (iv) fines migration and mineral reactions (Raza A, Arif M, Glatz G, Mahmoud M, Al Kobaisi M, Alafnan S, and researchers A holistic overview of underground hydrogen storage: Influencing factors, current understanding, and outlook. Fuel 2022; 330:125636.), which may significantly influence the initial and residual CO₂ saturations.

With such understanding established, recent studies in the context of UHS have explored the significance of saturation (pore and core scale) of residually trapped H₂ gas (S_{gr}), directly linked to the maximum initial gas saturation (S_{gi}) to estimate the flow and storage dynamics of porous media, as outlined in Table 1. As shown in Table 1, S_{gi} and S_{gr} have been determined through various methods including core flooding, rock imaging such as micro CT, and medical CT, and microfluidic studies. Notably, S_{gi} ranged from 0.04 to 0.76, with experiments conducted under ambient pressure exhibiting higher saturation than typically observed at storage pressures. Classically, S_{gi} within storage conditions varied from 0.22 to 0.60. While S_{gr} showed little sensitivity to pore pressure, it was significantly influenced by pore structure and brine equilibration, with values ranging from S_{gr}=0.017 to 0.48. These results indicate that a considerable amount of the injected working gas could be trapped within the pore space, highlighting the importance of cushion gas injection for improving working gas recovery.

The injection of cushion gas prior to the working gas, such as H₂, is important for several reasons. It acts as a pressure buffer within the storage reservoir, provides a safety measure by reducing the risk of H₂ loss, and aids in the controlled production of H₂ from the reservoir. This necessity arises because H₂, being the non-wetting phase, tends to occupy the central regions of large pores to form fluid clusters, while water usually resides as a thin film on the surface of the storage rock, within crevices, and in smaller throats and pores. As a result, injected H₂ is prone to inevitable losses due to residual trapping. This underscores why a strongly water-wet condition is typically not suitable for H₂ storage and production, as snap-off levels are influenced by the wettability of the system. An increase in the contact angle, away from strong water wetness, can significantly reduce the snap-off effect caused by residual trapping. For example, Hashemi and researchers (Scaling analysis of hydrogen flow with carbon dioxide cushion gas in subsurface heterogeneous porous media. Int J Hydrogen Energy 2022; 47:1752-64) demonstrated that increasing the contact angle toward 90° resulted in a reduction of trapped H₂ volume due to lower capillary pressure, thereby enhancing H₂ relative permeability during secondary imbibition.

Recent investigations by Lysyy and researchers [Lysyy M, Liu N, Landa-Marbán D, Ersland G, Fernø M. Impact of gas type on microfluidic drainage experiments and pore network modeling relevant for underground hydrogen storage. J Energy Storage 2024; 87.] have examined the behavior of different types of cushion gas using microfluidic drainage and pore network modeling (PNM) under conditions of 30 bar and 30 degrees Celsius (° C.), utilizing irregular sandstone-like pore structures. Their study assessed how gas type (pure H₂, a blend of 50 mole percent (mol %) H₂ and CH₄, pure CH₄, and pure nitrogen (N₂)) and injection rate impact gas flow patterns, saturation, connectivity within the pore structure, and the effect of pressure on H₂ drainage. While this study provided valuable insights into the use of cushion gas for UHS operations, additional research is needed to better understand the behavior of common cushion gases such as CH₄, CO₂, and N₂. Furthermore, the injection pattern, specifically the practice of injecting cushion gas ahead of the working gas in a single cycle, requires further investigation.

Yaseri and researchers (Investigation of gas residuals in sandstone formations via X-ray core-flooding experiments: Implication for subsurface hydrogen storage. International Journal of Hydrogen Energy, 2024, 78, 268-278) study a series of gas core-flooding experiments performed on a brine-saturated sandstone core sample using three different gases: CO₂, CH₄, and H₂.

Alshammari and researchers (The influence of CH₄ and CO₂ on the interfacial tension of H₂-Brine, Water-H₂-Rock wettability, and their implications on geological hydrogen storage. Energy & Fuels, 2024, 38, 16, 15834-15847) study the influence of CH₄ and CO₂ as cushion gases at different temperatures, pressures, and salinity conditions on the IFT of H₂-brine and water-H₂-rock wettability.

Isfehani and researchers (Sandstone wettability and mixed gas composition: Unraveling the impact of CO₂ in hydrogen geo-storage. International Journal of Hydrogen Energy. 2024, 59, 1352-1366) study the wettability hysteresis phenomenon by measuring the advancing and receding contact angles of different mixtures of H₂/CO₂ in contact with brine on a sandstone mineral under different pressures and temperatures.

TABLE 1
Gas saturations under different conditions and experimental configurations

| | | | K (mD); Φ | | |
|---|---|---|---|---|---|
| | Sample | Temp and | (%); S_{gi} (%); | Capillary | Displacement |
| Drainage fluid | preparation | Pressure | S_{gr} (%) | Number | type |
| Drainage fluid: | Sandstone | 30 °C and | K, mD: 2970 | — | 7.1 × 10⁻⁹ to |
| H₂ at 435 psi, | micromodel | 435 and | Φ (%): 61 | | 3.6 × 10⁻⁶, |
| H₂—CH₄, CH₄, | | 1450 psi | S_{gi} (%): 8 to | | 9.1 × 10⁻⁹ to |
| N₂, H₂ at 1450 | | | 39, 8 to 42, | | 4.5 × 10⁻⁶, |
| psi; Inhibition | | | 31 to 46, 26 | | 9.7 × 10⁻⁹ to |
| fluid: Water | | | to 44, 4 to 39 | | 4.9 × 10⁻⁶, |
| [Ref: 37] | | | S_{gr} (%): — | | 1.5 × 10⁻⁸ to |
| | | | | | 1.5 × 10⁻⁶, |
| | | | | | 7.4 × 10⁻⁹ to |
| | | | | | 3.7 × 10⁻⁶ |
| Drainage fluid: | Bentheimer | 25 °C and | K, mD: 653 | 2.92 × | Steady state |
| H₂; Inhibition | sandstone (50 | 308 psi | Φ (%): 23 | 10⁻⁵ to | |
| fluid: Non- | % T and 50 | | S_{gi} (%): 76 | 2.92 × | |
| equilibrated | % M) | | S_{gr} (%): 40 | 10⁻⁷ | |
| brine [Ref: 34] | | | | | |
| Drainage fluid: | Bentheimer | 50 °C and | K, mD: 2900 | 2.30 × | Unsteady state |
| H₂; Inhibition | sandstone | 1450 psi | Φ (%): 23 | 10⁻⁶ to | |
| fluid: | (100% M) | | S_{gi} (%): | 4.16 × | |
| Equilibrated | | | 36.30, 36.30 | 10⁻⁹ | |
| brine, non- | | | S_{gr} (%): 25, | | |
| equilibrated | | | 20 | | |
| brine [Ref: 28] | | | | | |
| Drainage fluid: | Clashach | 20 °C and | K, mD: — | 1.7-6.8 × | Unsteady and |
| H₂; Inhibition | sandstone | 290, 725, | Φ (%): 13 to | 10⁻⁸ to | steady state |
| fluid: 0.5M | (Untreated) | 1015 psi | 14 | 1.20-9.4 × | |
| CsCl [Ref: 32] | | | S_{gi} (%): 49.8, | 10⁻⁶ | |
| | | | 51.7, 39.7 to | | |
| | | | 52.6 | | |
| | | | S_{gr} (%): 10, | | |
| | | | 20, 4 to 21 | | |
| Drainage fluid: | Pure quartz | 20 °C and | K, mD: 2.97 | Steady- | |
| H₂; Inhibition | (untreated) | 580 psi | Darcy (D) | state | |
| fluid: water | | | Φ (%): 61 | | |
| [Ref: 38] | | | S_{gi} (%): 9 to | | |
| | | | 61, 6 to 73, 4 | | |
| | | | to 33, 3 to 48 | | |
| | | | S_{gr} (%): | | |
| | | | Drainage: | | |
| | | | 6.8 × 10⁻⁹ to | | |
| | | | 3.4 × 10⁻⁶, | | |
| | | | Inhibition: | | |
| | | | 7.7 × 10⁻⁷ to | | |
| | | | 3.4 × 10⁻⁴ | | |
| Drainage fluid: | Berea | 30 °C and | K, mD: 107 | 1.74 × 10⁻⁷ | Steady-state |
| H₂; Inhibition | sandstone | 435 psi | Φ (%): 18 | to 1.88 × | |
| fluid: | (Untreated) | | S_{gi} (%): 41 | 10⁻⁹ | |
| Equilibrated | | | S_{gr} (%): 36 | | |
| brine [Ref: 41] | | | (core flood | | |
| | | | with | | |
| | | | measured Pc) | | |
| Drainage fluid: | Berea | 18 °C and | K, mD: 203 | 1.1 × 10⁻⁶ | Steady-state |
| H₂; Inhibition | sandstone | 1450 psi | Φ (%): 19.7 | to 9.1 × | |
| fluid: Degassed | (Untreated) | | S_{gi} (%): 36 | 10⁻⁹ | |
| water [Ref: 35] | | | S_{gr} (%): 24 | | |
| Drainage fluid: | Sandstone | 80 °C and | K, mD: 16 | — | Unsteady state |
| H₂; Inhibition | (Untreated) | 14.5-3000 | Φ (%): 34 | | |
| fluid: Water | | psi | S_{gi} (%): 22 to | | |
| [Ref: 40] | | | 28 | | |
| | | | S_{gr} (%): — | | |
| Drainage fluid: | Vosges | 20 °C and | K, mD: 19 | 1.17-1.25 × | Steady-state |
| H₂; Inhibition | sandstone | 797 | Φ (%): 44 | 10⁻⁸ | |
| fluid: Water | (Untreated) | (shallow), | S_{gi} (%): 59 | | |
| [Ref: 25] | | 45 °C | (shallow), 60 | | |
| | | 1450 | (deep) | | |
| | | (deep) psi | S_{gr} (%): — | | |
| Drainage fluid: | Fontainebleau | 25 °C and | K, mD: 190 | 3.54 × 10⁻⁸ | Unsteady state |
| H₂, N₂, N₂; | sandstone | 58 psi | Φ (%): 10 | for H₂, | |
| Inhibition fluid: | (untreated) | | S_{gi} (%): 4.10, | 6.99 × 10⁻⁷ | |
| 3 wt. % NaCl | | | 26, 15 | for N₂, | |
| non-equilibrated | | | S_{gr} (%): 1.70, | 3.49 × 10⁻⁸ | |
| brine [Ref: 24] | | | 17, 8 | for N₂ | |
| Drainage fluid: | Gosford | ~20 °C | K, mD: 18 | 3.68 × 10⁻⁸ | Unsteady state |
| H₂, N₂, N₂; | sandstone | and 14.5 | Φ (%): — | to 2.49 × | |
| Inhibition fluid: | (untreated) | psi | S_{gi} (%): 65 | 10⁻¹⁰ | |
| Non- | | | S_{gr} (%): 41 | | |
| equilibrated 2M | | | | | |
| NaCl brine | | | | | |
| [Ref: 33] | | | | | |
| Drainage fluid: | Bandera grey | 25 °C and | K, mD: 26.8 | 1.9 × 10⁻⁸ | Unsteady state |
| H₂; Inhibition | sandstone | 60 psi | Φ (%): 19.3 | | |
| fluid: 3 wt. % | (untreated), | | S_{gi} (%): 16 | | |
| NaCl non- | Bandera grey | | (untreated), | | |
| equilibrated | sandstone | | 18 (treated) | | |
| brine [Ref: 26] | (treated) | | S_{gr} (%): 14 | | |
| | | | (untreated), | | |
| | | | 13 (treated) | | |

24. Al-Yaseri A, Esteban L, Giwelli A, Sarout J, Lebedev M, Sarmadivaleh M. Initial and residual trapping of hydrogen and nitrogen in Fontainebleau sandstone using nuclear magnetic resonance core flooding. Int J Hydrogen Energy 2022; 47:22482-94.
25. Yekta A E, Manceau J-C, Gaboreau S, Pichavant M, Audigane P. Determination of Hydrogen-Water Relative Permeability and Capillary Pressure in Sandstone: Application to Underground Hydrogen Injection in Sedimentary Formations. Transp Porous Media 2018; 122:333-56.
26. Al-Yaseri A, Esteban L, Yekeen N, Giwelli A, Sarout J, Sarmadivaleh M. The effect of clay on initial and residual saturation of hydrogen in clay-rich sandstone formation: Implications for underground hydrogen storage. Int J Hydrogen Energy 2023; 48:5175-85.
28. Jangda Z, Menke H, Busch A, Geiger S, Bultreys T, Lewis H, and researchers Pore-scale visualization of hydrogen storage in a sandstone at subsurface pressure and temperature conditions: Trapping, dissolution and wettability. J Colloid Interface Sci 2023; 629:316-25.
   32. Thaysen E M, Butler I B, Hassanpouryouzband A, Freitas D, Alvarez-Borges F, Krevor S, and researchers Pore-scale imaging of hydrogen displacement and trapping in porous media. Int J Hydrogen Energy 2023; 48:3091-106.
33. Jha N K, Al-Yaseri A, Ghasemi M, Al-Bayati D, Lebedev M, Sarmadivaleh M. Pore scale investigation of hydrogen injection in sandstone via X-ray micro-tomography. Int J Hydrogen Energy 2021; 46:34822-9.
34. Higgs S, Wang Y Da, Sun C, Ennis-King J, Jackson S J, Armstrong R T, and researchers Direct measurement of hydrogen relative permeability hysteresis for underground hydrogen storage. Int J Hydrogen Energy 2024; 50:524-41.
35. Boon M, Hajibeygi H. Experimental characterization of H 2/water multiphase flow in heterogeneous sandstone rock at the core scale relevant for underground hydrogen storage (UHS). Sci Rep 2022; 12:1-12.
36. Song H, Lao J, Zhang L, Xie C, Wang Y. Underground hydrogen storage in reservoirs: pore-scale mechanisms and optimization of storage capacity and efficiency. Appl Energy 2023; 337:120901.
37. Lysyy M, Liu N, Landa-Marbán D, Ersland G, Fernø M. Impact of gas type on microfluidic drainage experiments and pore network modeling relevant for underground hydrogen storage. J Energy Storage 2024; 87.
38. Lysyy M, Liu N, Solstad C M, Fernø M A, Ersland G. Microfluidic hydrogen storage capacity and residual trapping during cyclic injections: Implications for underground storage. Int J Hydrogen Energy 2023; 48:31294-304.
40. Rezaei A, Hassanpouryouzband A, Molnar I, Derikvand Z, Haszeldine R S, Edlmann K. Relative Permeability of Hydrogen and Aqueous Brines in Sandstones and Carbonates at Reservoir Conditions. Geophys Res Lett 2022; 49.
41. Lysyy M, Føyen T, Johannesen E B, Fernø M, Ersland G. Hydrogen Relative Permeability Hysteresis in Underground Storage. Geophys Res Lett 2022; 49.

CN117030531A uses the partial pressure of the cushion layer gas in the gas to be detected in the concentration sensor, which can monitor the cushion layer gas concentration of the inner lining type rock cave H₂ gas storage warehouse. The cushion layer gas concentration monitoring system can also be used in the H₂ gas storage such as a salt cavity. CN117588192A is related to a dry shale gas reservoir H₂ storage injection and production system and method. The method includes injecting a cushion layer gas into the exhausted shale gas reservoir. The cushion gas can be N₂, CH₄, CO₂ or H₂.

However, each of the processes, described herein, suffers from one or more drawbacks hindering their adoption. Accordingly, one object of the present disclosure is to provide a method for enhanced H₂ storage and recovery efficiency that may circumvent the drawbacks of the methods known in the art.

### SUMMARY

In an exemplary embodiment, a method of hydrogen (H₂) storage and withdrawal is described. The method includes executing a first cycle of low-speed storage and withdrawal, including injecting a first cushion gas into a subsurface formation including sandstone rock via an injection well at a first speed of 0.2-0.6 cubic per minute (cc/min)/225 grams (g) sandstone rock, injecting a first working gas into the subsurface formation at a second speed of 0.2-0.6 cc/min/225 g sandstone rock to store H₂ in the subsurface formation and obtain a first breakthrough, and injecting a first brine solution into the subsurface formation at a third speed of 0.1-0.3 cc/min/225 g sandstone rock to withdraw at least a portion of the H₂ from subsurface formation via a production well and obtain a second breakthrough. The first cushion gas includes 30-50 volume percent (vol. %) of methane (CH₄) and 50-70 vol. % of H₂ based on a total volume of the first cushion gas. The first working gas includes 70-100 vol. % of H₂ based on a total volume of the first working gas. A weight of the sandstone rock is a dry weight. The method further includes executing a second cycle of high-speed storage and withdrawal, including injecting a second cushion gas into the subsurface formation at a fourth speed of 1.2-10 cc/min/225 g sandstone rock, injecting a second working gas into the subsurface formation at a fifth speed of 1.2-10 cc/min/225 g sandstone rock to store more H₂ in the subsurface formation and obtain a third breakthrough, and injecting a second brine solution into the subsurface formation at a sixth speed of 0.1-0.3 cc/min/225 g sandstone rock to withdraw at least another portion of the H₂ from subsurface formation via the production well and obtain a fourth breakthrough. The second cushion gas includes 30-50 vol. % of carbon dioxide (CO₂) and 50-70 vol. % of H₂ based on a total volume of the second cushion gas. The second working gas includes 70-100 vol. % of H₂ based on a total volume of the second working gas.

In some embodiments, the first cushion gas includes about 40 vol. % of CH₄ and about 60 vol. % of H₂ based on the total volume of the first cushion gas.

In some embodiments, a H₂ recovery factor (RF) of the first cycle is 37.76 to 46.33.

In some embodiments, the second cushion gas includes about 40 vol. % of CO₂ and about 60 vol. % of H₂ based on the total volume of the second cushion gas.

In some embodiments, a H₂ RF of the second cycle is 32.36 to 34.35.

In some embodiments, the first cushion gas does not include CO₂.

In some embodiments, the second cushion gas does not include CH₄.

In some embodiments, the sandstone rock includes, based on the weight of the sandstone rock: 50-75 weight percent (wt. %) of quartz, 5-15 wt. % of dolomite, 10-20 wt. % of albite, 0-1 wt. % of anorthoclase, 5-15 wt. % of illite, and 1-9 wt. % of kaolinite.

In some embodiments, the sandstone rock includes, based on the weight of the sandstone rock: 63.5 wt. % of quartz, 8.6 wt. % of dolomite, 14.7 wt. % of albite, 0.2 wt. % of anorthoclase, 8.5 wt. % of illite, and 4.2 wt. % of kaolinite.

In some embodiments, the sandstone rock has a porosity of 18-20% and a nitrogen gas (N₂) permeability of 25-26 millidarcy (mD).

In some embodiments, the method further includes injecting an initial brine solution into the subsurface formation at an initial speed of 0.1-0.3 cc/min/225 g sandstone rock, before the executing the first cycle.

In some embodiments, the first working gas includes 95-100 vol. % of H₂ based on the total volume of the first working gas, and the second working gas includes 95-100 vol. % of H₂ based on the total volume of the second working gas.

In some embodiments, the first speed and the second speed are identical, and the fourth speed and the fifth speed are identical.

In some embodiments, the third speed is about 0.2 cc/min/225 g sandstone rock, and the sixth speed is about 0.2 cc/min/225 g sandstone rock.

In some embodiments, the first brine solution includes 1-10 wt. % of sodium chloride (NaCl) based on a total weight of the first brine solution, and the second brine solution includes 1-10 wt. % of NaCl based on a total weight of the second brine solution.

In some embodiments, the first brine solution includes about 5 wt. % of NaCl based on the total weight of the first brine solution, and the second brine solution includes about 5 wt. % of NaCl based on the total weight of the second brine solution.

In some embodiments, the method further includes measuring an electrical resistivity of the subsurface formation during the first cycle and the second cycle, and determining a corresponding breaking when the electrical resistivity is stable.

In some embodiments, the first cycle is executed before the second cycle.

In some embodiments, in the first cycle, the first cushion gas is injected before the first working gas is injected, and the first working gas is injected before the first brine solution is injected.

In some embodiments, in the second cycle, the second cushion gas is injected before the second working gas is injected, and the second working gas is injected before the second brine solution is injected.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings.

FIG. 1A illustrates a schematic flow chart of a method of hydrogen (H₂) storage and withdrawal, according to certain embodiments.

FIG. 1B illustrates four sister core plug samples of Bandera Grey (BG) sandstone, acquired from Ward's Natural Science, the United States of America (USA), according to certain embodiments.

FIG. 2 is a schematic illustration of core flood setup equipped with inductance capacitance resistance (LCR), according to certain embodiments.

FIG. 3A is a resistance profile during gas injection and withdrawal cycles for 100 percent (%) H₂ [sample #1], according to certain embodiments.

FIG. 3B is a resistance profile during gas injection and withdrawal cycles for 60% H₂-40% methane (CH₄) [sample #2], according to certain embodiments.

FIG. 3C is a resistance profile during gas injection and withdrawal cycles for 60% H₂-40% nitrogen (N₂) [sample #3], according to certain embodiments.

FIG. 3D is a resistance profile during gas injection and withdrawal cycles for 60% H₂-40% carbon dioxide (CO₂) [sample #4], according to certain embodiments.

FIG. 4A is a plot of calculated initial (S_{gi}) and residual (S_{gr}) gas saturation for H₂ at 42 degrees Celsius (° C.), 1400 pounds per square inch (psi) pressure, and n=2; data is fitted based on Land's model with each showing a different trapping capacity, according to certain embodiments.

FIG. 4B is a plot of S_{gi} and S_{gr} for 60% H₂-40% CH₄ at 42° C., 1400 psi pressure, and n=2; data is fitted based on Land's model with each showing a different trapping capacity, according to certain embodiments.

FIG. 4C is a plot of S_{gi} and Ser for 60% H₂-40% N₂ at 42° C., 1400 psi pressure, and n=2; data is fitted based on Land's model with each showing a different trapping capacity, according to certain embodiments.

FIG. 4D is a plot of S_{gi} and S_{gr} for 60% H₂-40% CO₂ at 42° C., 1400 psi pressure, and n=2; data is fitted based on Land's model with each showing a different trapping capacity, according to certain embodiments.

FIG. 4E is a combined plot of S_{gi} and Ser for all samples at 42° C., 1400 psi pressure, and n=2; data is fitted based on Land's model with each showing a different trapping capacity, according to certain embodiments.

FIG. 5 is a comparison of S_{gi} and S_{gr} with various literature data with using Land's empirical model with the trapping coefficients, C=1.9423, according to certain embodiments.

FIG. 6A shows S_{gi} and S_{gr} for cycle 1 (gas injection rate (Q_{g})=0.2 cubic centimeter per minute (cc/min) and brine injection rate (Q_{b})=0.2 cc/min) for H₂ and H₂+cushion gas injection, according to certain embodiments.

FIG. 6B shows S_{gi} and Ser for cycle 2 (Q_{g}=0.6 cc/min and Q_{b}=0.2 cc/min) for H₂ and H₂+cushion gas injection, according to certain embodiments.

FIG. 6C shows S_{gi} and S_{gr} for cycle 3 (Q_{g}=1.2 cc/min and Q_{b}=0.2 cc/min) for H₂ and H₂+cushion gas injection, according to certain embodiments.

FIG. 6D shows S_{gi} and S_{gr} for cycle 4 (Q_{g}=2 cc/min and Q_{b}=0.2 cc/min) for H₂ and H₂+cushion gas injection, according to certain embodiments.

FIG. 6E shows S_{gi} and Ser for cycle 5 (Q_{g}=5 cc/min and Q_{b}=0.2 cc/min) for H₂ and H₂+cushion gas injection, according to certain embodiments.

FIG. 6F shows S_{gi} and S_{gr} for cycle 6 (Q_{g}=10 cc/min and Q_{b}=0.2 cc/min) for H₂ and H₂+cushion gas injection, according to certain embodiments.

FIG. 7A shows gas recovery for cycle 1 for H₂ and H₂+cushion gas injection, according to certain embodiments.

FIG. 7B shows gas recovery for cycle 2 for H₂ and H₂+cushion gas injection, according to certain embodiments.

FIG. 7C shows gas recovery for cycle 3 for H₂ and H₂+cushion gas injection, according to certain embodiments.

FIG. 7D shows gas recovery for cycle 4 for H₂ and H₂+cushion gas injection, according to certain embodiments.

FIG. 7E shows gas recovery for cycle 5 for H₂ and H₂+cushion gas injection, according to certain embodiments.

FIG. 7F shows gas recovery for cycle 6 for H₂ and H₂+cushion gas injection, according to certain embodiments.

FIG. 8A shows a nuclear magnetic resonance (NMR) distribution for pre- and post-core flooding of sample #1, according to certain embodiments.

FIG. 8B shows an NMR distribution for pre- and post-core flooding of sample #2, according to certain embodiments.

FIG. 8C shows an NMR distribution for pre- and post-core flooding of sample #3, according to certain embodiments.

FIG. 8D shows an NMR distribution for pre- and post-core flooding of sample #4, according to certain embodiments.

FIG. 9A shows porosity before and after core flooding with H₂ and H₂+cushion gas in all samples, according to certain embodiments.

FIG. 9B shows permeability before and after core flooding with H₂ and H₂+cushion gas in all samples, according to certain embodiments.

### DETAILED DESCRIPTION

When describing the present disclosure, the terms used are to be construed in accordance with the following definitions, unless a context dictates otherwise.

Embodiments of the present disclosure will now be described more fully hereinafter with reference to the accompanying drawings wherever applicable, in that some, but not all, embodiments of the disclosure are shown.

In the drawings, like reference numerals designate identical or corresponding parts throughout the several views. Further, as used herein, the words ‘a,’ ‘an’ and the like generally carry a meaning of ‘one or more,’ unless stated otherwise.

Furthermore, the terms ‘approximately,’ ‘approximate,’ ‘about,’ and similar terms generally refer to ranges that include the identified value within a margin of 20%, 10%, or preferably 5%, and any values therebetween.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

As used herein, the term ‘permeability’ refers to the capacity of a porous material to transmit fluids through its pore spaces under an applied pressure gradient. It is a property in determining fluid flow in subsurface reservoirs, with higher permeability allowing easier fluid movement. Permeability is typically measured in millidarcies (mD) or darcies (D).

As used herein, the term ‘pore’ refers to a small opening or space in a material, such as rock or soil, through which fluids or gases can pass.

As used herein, the term ‘porosity’ refers to a measure of the void or vacant spaces within a material.

As used herein, the term ‘pore space’ refers to the interconnected voids or spaces within a porous material, such as rock or soil, that can hold fluids, gases, or other substances. These spaces play a role in processes like fluid movement, storage, and recovery within subsurface formations.

As used herein, the term ‘pore fluid’ refers to a liquid or gas that occupies the pore spaces within a porous material, such as rock or sediment. This fluid can be water, oil, gas, or other substances that are present in the pores of the material, playing a key role in fluid flow and transport processes within the subsurface.

As used herein, the term ‘pore aspect ratio’ refers to the ratio of the longest dimension (length) to the shortest dimension (width or height) of an individual pore within a porous material. It is a measure of the shape of the pores, where a higher aspect ratio indicates an elongated pore and a lower ratio indicates more circular or spherical pores. This parameter can influence fluid flow, permeability, and the material's overall porosity.

As used herein, the term ‘pore size’ may be thought of as an average dimension of a pore opening.

As used herein, the term ‘pore volume’ refers to the total volume of void spaces (pores) within a material that is capable of being filled by a gas or liquid. It is typically expressed in cubic centimeters per gram (cc/g) and is an important parameter in characterizing the porous structure of materials, such as adsorbents or catalysts.

As used herein, the term ‘pore pressure’ refers to the pressure exerted by fluids (such as water, oil, or gas) within the pores of a porous material, typically a rock or sediment. Pore pressure is typically measured in situ to assess the stress conditions and the potential for fluid migration in subsurface environments.

As used herein, the term ‘subsurface formation’ refers to the layers of rock, soil, and other geological materials located beneath the Earth's surface, which can contain fluids such as water, oil, gas, or hydrogen (H₂), and are of interest in activities like resource extraction and storage.

As used herein, the term ‘reservoir’ refers to a subsurface geological formation that contains significant quantities of fluids, such as oil, gas, water, or H₂, which are stored within its porous rock structure.

As used herein, ‘production well’ refers to a drilled well designed to extract oil, gas, brine, or other fluids from underground reservoirs.

As used herein, ‘brine’ refers to a solution of water and dissolved salts, such as sodium chloride (NaCl).

As used herein, the term ‘capillary number’ refers to a dimensionless number that quantifies the relative importance of viscous forces to capillary forces during fluid flow in porous media. It is typically defined as the ratio of viscous forces (related to fluid velocity and viscosity) to capillary forces (related to surface tension and pore structure) and is used to predict the flow behavior of fluids, especially in the context of enhanced oil recovery and H₂ storage.

As used herein, the term ‘gas saturation profile’ refers to the distribution or variation of gas saturation within a porous medium, such as a reservoir rock or subsurface formation. This profile represents the amount of gas present in the pore spaces of the medium at different locations or depths, and it is important for understanding gas flow, storage capacity, and recovery efficiency, particularly in processes like gas injection or H₂ storage.

As used herein, the term ‘cushion gas’ refers to the gas that is injected and stored in a reservoir to maintain pressure and support the extraction of a working gas.

As used herein, the term ‘working gas’ refers to the gas that is injected into a reservoir for storage and can be extracted for use during production. It is the primary gas that is intended to be recovered and utilized, in contrast to cushion gas, which may remain in the reservoir to maintain pressure. Working gas plays a role in gas storage operations and can be subjected to cycles of injection and withdrawal to meet demand.

As used herein, the term ‘wettability’ refers to the tendency of a solid surface, such as a rock or porous material, to be either preferentially wetted by one fluid phase over another.

As used herein, the term ‘injection rate’ refers to the speed or volume at which a fluid, such as gas or liquid, is introduced into a system or a subsurface formation.

As used herein, the term ‘H₂ recovery factor’ refers to the proportion of H₂ gas that can be effectively recovered from a storage reservoir compared to the total amount of H₂ initially injected into the reservoir. It is a metric in evaluating the efficiency of H₂ storage systems. The recovery factor (RF) is influenced by several factors, including reservoir characteristics, storage conditions (such as temperature and pressure), and the mechanisms of gas trapping or loss within the formation. A higher H₂ RF indicates a more efficient and successful recovery process for stored H₂.

As used herein, the term ‘electrical resistivity’ refers to the measurement of a material's ability to resist the flow of electric current, which is typically used in geological and petroleum engineering contexts to assess fluid saturation and the conductivity of subsurface formations.

In addition, the present disclosure is intended to include all isotopes of atoms occurring in the present compounds and complexes. Isotopes include those atoms having the same atomic number but different mass numbers. By way of general example, and without limitation, isotopes of H₂ include deuterium and tritium, and isotopes of carbon include ¹³C and ¹⁴C. Isotopes of oxygen include ¹⁶O, ¹⁷O, and ¹⁸O. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

Aspects of the present disclosure are directed towards a method for enhanced H₂ storage and recovery efficiency. The device enhances H₂ storage and recovery efficiency by improving storage capacity, enhancing recovery rates, and offering a more stable and cost-effective solution under varying operational conditions.

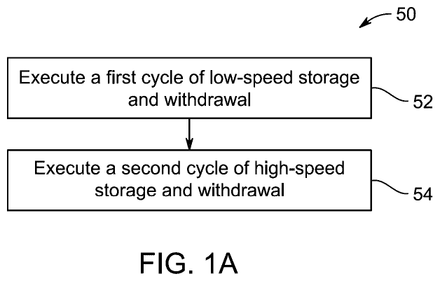

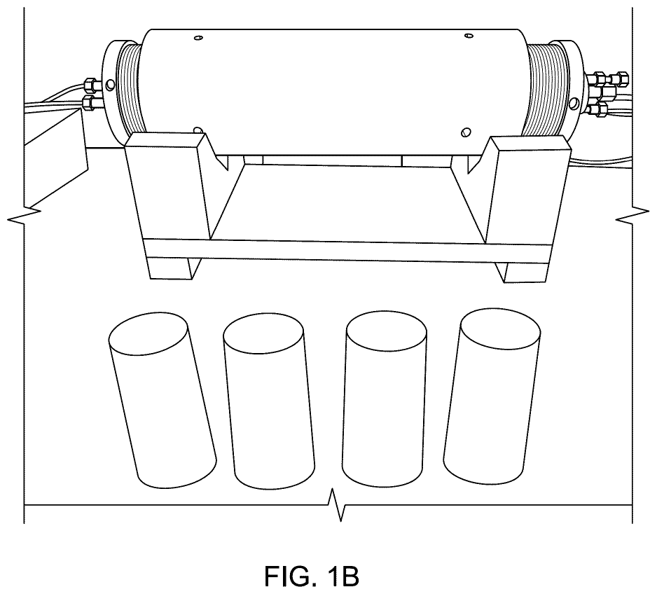

FIG. 1A illustrates a schematic flow chart of a method 50 of H₂ storage and withdrawal. The order in which the method 50 is described is not intended to be construed as a limitation, and any number of the described method steps can be combined to implement the method 50. Additionally, individual steps may be removed or skipped from the method 50 without departing from the spirit and scope of the present disclosure.

At step 52, the method 50 includes executing a first cycle of low-speed storage and withdrawal. Low-speed storage can be beneficial for maintaining reservoir integrity, controlling gas saturation profiles, and improving long-term storage efficiency. The execution of the first cycle of low-speed storage and withdrawal includes injecting a first cushion gas into a subsurface formation including sandstone rock via an injection well at a first speed of 0.2-0.6 cubic per minute (cc/min)/225 grams (g) sandstone rock, preferably 0.22-0.58 cc/min/225 g, preferably 0.24-0.56 cc/min/225 g, preferably 0.26-0.54 cc/min/225 g, preferably 0.28-0.52 cc/min/225 g, preferably 0.30-0.50 cc/min/225 g, preferably 0.32-0.48 cc/min/225 g, preferably 0.34-0.46 cc/min/225 g, preferably 0.36-0.44 cc/min/225 g, and preferably 0.38-0.42 cc/min/225 g sandstone rock. In some embodiments, a weight of the sandstone rock is a dry weight, wet weight, saturated weight, bulk weight, or apparent weight, depending on the presence of fluids or buoyancy effects. In a preferred embodiment, the weight of the sandstone rock is a dry weight.

In some embodiments, the sandstone rock includes, 50-75 wt. % of quartz (preferably 51-74 wt. %, preferably 52-73 wt. %, preferably 53-72 wt. %, preferably 54-71 wt. %, preferably 55-70 wt. %, preferably 56-69 wt. %, preferably 57-68 wt. %, preferably 58-67 wt. %, preferably 59-66 wt. %, preferably 60-65 wt. %, preferably 61-64 wt. %, preferably 62-63 wt. % of quartz), 5-15 wt. % of dolomite (preferably 6-14 wt. %, preferably 7-13 wt. %, preferably 8-12 wt. %, and preferably 9-11 wt. % of dolomite), 10-20 wt. % of albite (preferably 11-19 wt. %, preferably 12-18 wt. %, preferably 13-17 wt. %, preferably 14-16 wt. % of albite), 0-1 wt. % of anorthoclase (preferably 0.1-0.9 wt. %, preferably 0.2-0.8 wt. %, preferably 0.3-0.7 wt. %, and preferably 0.4-0.6 wt. % of anorthoclase), 5-15 wt. % of illite (preferably 6-14 wt. %, preferably 7-13 wt. %, preferably 8-12 wt. %, and preferably 9-11 wt. % of illite), and 1-9 wt. % of kaolinite (preferably 2-8 wt. %, preferably 3-7 wt. %, and preferably 4-6 wt. % kaolinite), based on a total weight of the sandstone rock. In a preferred embodiment, the sandstone rock includes, 63.5 wt. % of quartz, 8.6 wt. % of dolomite, 14.7 wt. % of albite, 0.2 wt. % of anorthoclase, 8.5 wt. % of illite, and 4.2 wt. % of kaolinite, based on the total weight of the sandstone rock.

In some embodiments, the sandstone rock has a porosity of 18-20%, preferably 18.1-19.9 wt. %, preferably 18.2-19.8 wt. %, preferably 18.3-19.7 wt. %, preferably 18.4-19.6 wt. %, preferably 18.5-19.5 wt. %, preferably 18.6-19.4 wt. %, preferably 18.7-19.3 wt. %, preferably 18.8-19.2 wt. %, and preferably 18.9-19.1 wt. % and a nitrogen (N₂) gas permeability of 25-26 mD, preferably 25.1-25.9 mD, preferably 25.2-25.8 mD, preferably 25.3-25.7 mD, and preferably 25.4-25.6 mD.

In some embodiments, the first cushion gas includes 30-50 volume percent (vol. %) of CH₄ (preferably 31-49 vol. %, preferably 32-48 vol. %, preferably 33-47 vol. %, preferably 34-46 vol. %, preferably 35-45 vol. %, preferably 36-44 vol. %, preferably 37-43 vol. %, preferably 38-42 vol. %, preferably 39-41 vol. % of CH₄) and 50-70 vol. % of H₂ (preferably 51-69 vol. %, preferably 52-68 vol. %, preferably 53-67 vol. %, preferably 54-66 vol. %, preferably 55-65 vol. %, preferably 56-64 vol. %, preferably 57-63 vol. %, preferably 58-62 vol. %, and preferably 59-61 vol. % of H₂) based on a total volume of the first cushion gas. In a preferred embodiment, the first cushion gas includes about 40 vol. % of CH₄ and about 60 vol. % of H₂ based on the total volume of the first cushion gas. In some embodiments, the first cushion gas does not include carbon dioxide (CO₂).

The execution of the first cycle of low-speed storage and withdrawal further includes injecting a first working gas into the subsurface formation at a second speed of 0.2-0.6 cc/min/225 g sandstone rock, preferably 0.22-0.58 cc/min/225 g, preferably 0.24-0.56 cc/min/225 g, preferably 0.26-0.54 cc/min/225 g, preferably 0.28-0.52 cc/min/225 g, preferably 0.30-0.50 cc/min/225 g, preferably 0.32-0.48 cc/min/225 g, preferably 0.34-0.46 cc/min/225 g, preferably 0.36-0.44 cc/min/225 g, and preferably 0.38-0.42 cc/min/225 g to store H₂ in the subsurface formation and obtain a first breakthrough.

In some embodiments, the first working gas includes 70-100 vol. % of H₂, preferably 71-99 vol. %, preferably 72-98 vol. %, preferably 73-97 vol. %, preferably 74-96 vol. %, preferably 75-95 vol. %, preferably 76-94 vol. %, preferably 77-93 vol. %, preferably 78-92 vol. %, preferably 79-91 vol. %, preferably 80-90 vol. %, preferably 81-89 vol. %, preferably 82-88 vol. %, preferably 83-87 vol. %, and preferably 84-86 vol. % of H₂ based on a total volume of the first working gas.

The execution of the first cycle of low-speed storage and withdrawal further includes injecting a first brine solution into the subsurface formation at a third speed of 0.1-0.3 cc/min/225 g sandstone rock, preferably 0.11-0.29 cc/min/225 g, preferably 0.12-0.28 cc/min/225 g, preferably 0.13-0.27 cc/min/225 g, preferably 0.14-0.26 cc/min/225 g, preferably 0.15-0.25 cc/min/225 g, preferably 0.16-0.24 cc/min/225 g, preferably 0.17-0.23 cc/min/225 g, preferably 0.18-0.22 cc/min/225 g, and preferably 0.19-0.21 cc/min/225 g to withdraw at least a portion of the H₂ from subsurface formation via a production well and obtain a second breakthrough.

In some embodiments, in the first cycle, the first cushion gas is injected before the first working gas is injected, and the first working gas is injected before the first brine solution is injected. In some embodiments, a H₂ RF of the first cycle is 37.76-46.33, preferably 38.26-45.83, preferably 38.76-45.33, preferably 39.26-44.83, preferably 39.76-44.33, preferably 40.26-43.83, preferably 40.76-43.33, preferably 41.26-42.83, and preferably 41.76-42.33.

At step 54, the method 50 includes executing a second cycle of high-speed storage and withdrawal. High-speed storage can enable the rapid injection of H₂ or gas into a subsurface formation to improve storage capacity and efficiency. The execution of the second cycle of high-speed storage and withdrawal includes injecting a second cushion gas into the subsurface formation at a fourth speed of 1.2-10 cc/min/225 g sandstone rock, 1.7-9.5 cc/min/225 g, preferably 2.2-9 cc/min/225 g, preferably 2.7-8.5 cc/min/225 g, preferably 3.2-8 cc/min/225 g, preferably 3.7-7.5 cc/min/225 g, preferably 4.2-7 cc/min/225 g, preferably 4.7-6.5 cc/min/225 g, and preferably 5.2-6 cc/min/225 g sandstone rock. In some embodiments, the first cycle is executed before the second cycle.

In some embodiments, the second cushion gas includes 30-50 vol. % of CO₂ (preferably 31-49 vol. %, preferably 32-48 vol. %, preferably 33-47 vol. %, preferably 34-46 vol. %, preferably 35-45 vol. %, preferably 36-44 vol. %, preferably 37-43 vol. %, preferably 38-42 vol. %, and preferably 39-41 vol. % of CO₂) and 50-70 vol. % of H₂ (preferably 51-69 vol. %, preferably 52-68 vol. %, preferably 53-67 vol. %, preferably 54-66 vol. %, preferably 55-65 vol. %, preferably 56-64 vol. %, preferably 57-63 vol. %, preferably 58-62 vol. %, and preferably 59-61 vol. % of H₂) based on a total volume of the second cushion gas. In a preferred embodiment, the second cushion gas includes about 40 vol. % of CO₂ and about 60 vol. % of H₂ based on the total volume of the second cushion gas. In some embodiments, the second cushion gas does not include CH₄.

The execution of the second cycle of high-speed storage and withdrawal further includes injecting a second working gas into the subsurface formation at a fifth speed of 1.2-10 cc/min/225 g sandstone rock, 1.7-9.5 cc/min/225 g, preferably 2.2-9 cc/min/225 g, preferably 2.7-8.5 cc/min/225 g, preferably 3.2-8 cc/min/225 g, preferably 3.7-7.5 cc/min/225 g, preferably 4.2-7 cc/min/225 g, preferably 4.7-6.5 cc/min/225 g, and preferably 5.2-6 cc/min/225 g sandstone rock to store more H₂ in the subsurface formation and obtain a third breakthrough.

In some embodiments, the second working gas includes 70-100 vol. % of H₂, preferably 71-99 vol. %, preferably 72-98 vol. %, preferably 73-97 vol. %, preferably 74-96 vol. %, preferably 75-95 vol. %, preferably 76-94 vol. %, preferably 77-93 vol. %, preferably 78-92 vol. %, preferably 79-91 vol. %, preferably 80-90 vol. %, preferably 81-89 vol. %, preferably 82-88 vol. %, preferably 83-87 vol. %, and preferably 84-86 vol. % of H₂ based on a total volume of the second working gas.

The execution of the second cycle of high-speed storage and withdrawal further includes injecting a second brine solution into the subsurface formation at a sixth speed of 0.1-0.3 cc/min/225 g sandstone rock, preferably 0.11-0.29 cc/min/225 g, preferably 0.12-0.28 cc/min/225 g, preferably 0.13-0.27 cc/min/225 g, preferably 0.14-0.26 cc/min/225 g, preferably 0.15-0.25 cc/min/225 g, preferably 0.16-0.24 cc/min/225 g, preferably 0.17-0.23 cc/min/225 g, preferably 0.18-0.22 cc/min/225 g, and preferably 0.19-0.21 cc/min/225 g to withdraw at least another portion of the H₂ from subsurface formation via the production well and obtain a fourth breakthrough. In some embodiments, the third speed is about 0.2 cc/min/225 g sandstone rock, and the sixth speed is about 0.2 cc/min/225 g sandstone rock.

In some embodiments, the first speed and the second speed are identical, and the fourth speed and the fifth speed are identical. The first speed is smaller than the third speed while the second speed is smaller than the fourth speed.

In some embodiments, in the second cycle, the second cushion gas is injected before the second working gas is injected, and the second working gas is injected before the second brine solution is injected. In some embodiments, a H₂ RF of the second cycle is 32.36-34.35, preferably 32.46-34.25, preferably 32.56-34.15, preferably 32.66-34.05, preferably 32.76-33.95, preferably 32.86-33.85, preferably 32.96-33.75, preferably 33.06-33.65, preferably 33.16-33.55, and preferably 33.26-33.45.

In some embodiments, the first working gas includes 95-100 vol. % of H₂, preferably 96-99 vol. %, preferably 97-98 vol. %, and preferably 98-99 vol. % of H₂ based on the total volume of the first working gas, and the second working gas includes 95-100 vol. % of H₂, preferably 96-99 vol. %, preferably 97-98 vol. %, and preferably 98-99 vol. % of H₂ based on the total volume of the second working gas.

In some embodiments, the first brine solution includes 1-10 wt. %, preferably 2-9 wt. %, preferably 3-8 wt. %, preferably 4-7 wt. %, and preferably 5-6 wt. % of NaCl based on a total weight of the first brine solution, and the second brine solution includes 1-10 wt. %, preferably 2-9 wt. %, preferably 3-8 wt. %, preferably 4-7 wt. %, and preferably 5-6 wt. % of NaCl based on a total weight of the second brine solution. In a preferred embodiment, the first brine solution includes about 5 wt. % of NaCl based on the total weight of the first brine solution, and the second brine solution includes about 5 wt. % of NaCl based on the total weight of the second brine solution.

In some embodiments, the method further includes measuring an electrical resistivity of the subsurface formation during the first cycle and the second cycle, and determining a corresponding breaking (e.g. the aforementioned first, second, third and fourth breakthroughs) when the electrical resistivity is stable. The stability of the electrical resistivity signals when the formation has reached a point of equilibrium, or breaking, which improves gas injection.

### EXAMPLES

### Example 1: Materials

Research-grade gases, including pure hydrogen (H₂), methane (CH₄), nitrogen (N₂), and carbon dioxide (CO₂) with a purity of 99.999 percent (%), were sourced from Air Liquid Saudi Arabia for the resistivity core flood experiment. Four sister core plug samples of Bandera Grey (BG) sandstone, acquired from Ward's Natural Science, the United States of America (USA), as illustrated in FIG. 1B, were utilized for the experimental investigation. The mineral distribution of the samples were determined through X-ray diffraction (XRD) analysis. The four samples of Core ID #1, Core ID #2, Core ID #3 and Core ID #4 all have a composition of 63.5±1 wt. % of quartz, 8.6±0.6 wt. % of dolomite, 14.7±0.2 wt. % of albite, 0.2±0.2 wt. % of anorthoclase, 8.5±1.2 wt. % of illite and 4.2±0.4 wt. % of kaolinite based on a total weight of the composition. Sodium chloride (NaCl) salt obtained from Sigma Aldrich was used for the brine preparation. The experimental conditions mirrored reservoir conditions, set at 42° C. temperature, a pressure of 1400 pounds per square inch (psi), and a salinity of 5 weight percent (wt. %) NaCl, emulating RAG field underground sun storage. RAG Field Underground Sun Storage” refers to a flagship hydrogen storage project developed by RAG Austria. It is the world's first pilot-scale facility demonstrating large-scale, seasonal hydrogen storage in depleted natural gas reservoirs—often referred to as ‘underground sun’ due to its role in storing renewable solar energy in the form of hydrogen. The goal was to determine whether hydrogen, produced from surplus renewable electricity, could be safely and effectively stored in subsurface formations alongside natural gas. Conducted in two phases-basic research (laboratory studies, simulations) and field testing—the project proved that injecting up to 10% hydrogen into natural gas reservoirs does not compromise reservoir integrity. This pioneering project involved interdisciplinary collaboration among universities and industry partners, supported by the Austrian Climate and Energy Fund.

### Example 2: Core Sample Cleaning

Initially, the core samples were cut and end-faced to ensure smoothness. Thereafter, the core samples underwent cleaning for 4 hours (h) using a distillation-extraction method with toluene. Following this, the core samples were dried in a conventional heating oven at 70° C. for 5 h after rinsing with deionized water to ensure that blockage due to end facing and distillation extraction cleaning process was eliminated. The heating continued until the dry weight after several measurements became constant.

### Example 3: Porosity and Permeability Measurements

The samples' porosity was measured using nuclear magnetic resonance (NMR), and gravimetric methods before and after the experiment. NMR techniques were employed for quality control, examining pore sizes and distributions using a GeoSpec 2-75 core analyzer. The NMR spectroscopy method analyzed H₂ molecule decay time post-magnetic pulse stimulation, generating spin-echo signals from relaxing molecules in pores, with factors like T2 relaxation time and gradient molecule diffusion influencing the signal and aiding in pore size determination. Incremental and cumulative porosity were assessed alongside T2 relaxation time. Gravimetric porosity was determined using the saturated core samples. For permeability assessment before and after the experiment, the gas permeameter capable of measuring up to 10 D using N₂ gas, was employed to gauge the core samples' permeability.

### Example 4: Brine Preparation and Core Saturation

The 5 wt. % brine solution was prepared by NaCl salts in laboratory-grade deionized (DI) water, which displayed an electrical conductivity of 0.02 microsiemens/centimeter (μS·cm⁻¹) at 25° C., achieving uniformity through stirring with a heated magnetic stirrer (for 2 h). At room temperature, the core samples were saturated using a high-pressure vessel with 2000 psi pressure with any trapped air removed via an air ejector vacuum before saturation. After being kept in the vessel for 96 h (4 days), the samples were retrieved for subsequent analysis. Porosity by gravimetry was also computed. Herein, the method calculates the brine-filled pore volume (Vₚₒᵣₑ), utilizing Eq. (1),

Vₚₒᵣₑ=(mₛₐₜ−m_{dry})/ρ_{brine} (1),

where mₛₐₜ and m_{dry} representing the saturated and dry weight (in grams (g)) of the cores, respectively. The brine density (ρ_{brine}) was measured as 1.026 gram per cubic centimeter (g/cc) at 25° C. using Anton Paar Density Meter. Finally, the gravimetric porosity (@) was computed using Eq. (2),

Φ=Vₚₒᵣₑ/V_{bulk} (2),

where V_{bulk}=[((πd²)/4)×L], where d and L respectively denote the core samples' diameter and length (in millimeters (mm)).

### Example 5: Core Flooding Setup

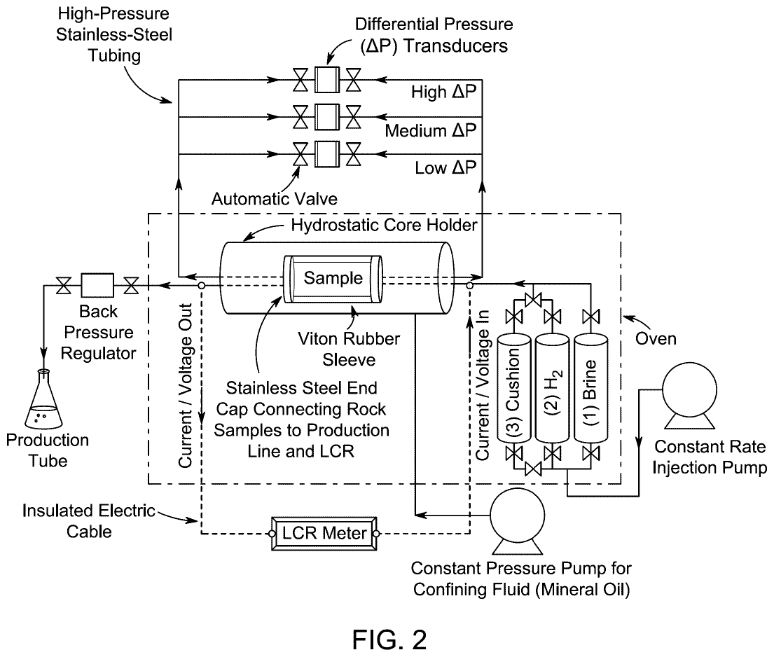

FIG. 2 represents the core flooding setup utilized to monitor in situ saturation changes (as a function of resistance) during gas drainage and subsequent brine imbibition. This system is designed with a two-pole electrical resistivity system that enables the detection of dynamic saturation changes during the injection processes. Resistivity measurements were conducted when an electric current passed through the core sample using the inductance-capacitance-resistance (LCR) meter shown in FIG. 2. An instrument specialties company (ISCO) syringe pump facilitated the injection of stored fluids from the two (Exp 1) or three (Exp 2, 3 and 4) accumulators-through the rock sample at varying rates (brine injection rate=0.2 cc/min, gas injection rates=0.2, 0.6, 1.2, 2, 5 and 10 cubic centimeter per minute (cc/min)). The system pressure was regulated at 1400 psi using a back-pressure regulator, while a constant pump pressure upheld the confining pressure at 2100 psi. This was achieved by injecting mineral oil into the space between the rubber sleeve, which contains the core sample, and the core holder. Real-time experimental data were also recorded on the computer.

### Example 6: Experimental Procedure

After core cleaning, porosity, permeability measurement, and core saturation, the following experimental protocol was conducted:
i. Loaded the sample into the core holder.
ii. Applied confining pressure of 2100 psi using mineral oil.
iii. The pore pressure and confining pressure were gradually increased simultaneously using 5 wt. % NaCl brine and mineral oil respectively by maintaining a 600 psi pressure difference until a pore pressure above breakdown pressure (BPR) (1400 psi) was attained and brine was produced from the sample.
iv. The heating device was activated to raise the temperature of the flow system to 42° C., allowing sufficient time for the system to stabilize.

### Example 7: H₂ Gas Injection Scenario (Exp 1)

a. Loaded a new core sample based on procedures i to iv. Then, a “dead” brine was injected into the porous media at a rate of 0.2 cc/min to maintain 100% saturation until reaching a steady state. This state was identified when the flow rate entering the system matched the flow rate exiting it, and when the pressure difference across the core reached a consistent level. This stability was confirmed when the average pressure difference fluctuated within a narrow range between two distinct values. Also, the electrical resistance of the rock, saturated with the brine solution, was measured and documented as the Rₒ value. It is important to note that the equilibrium resistance or pressure drop at full saturation is henceforth denoted as the “global steady state”.
b. Cycle 1 started with flooding the rock with pure H₂ gas (drainage) at a pure H₂ gas flow rate of 0.2 cc/min until reaching a steady-state following gas breakthrough and a constant resistance over some time.
c. Subsequently, dead brine (imbibition) was reinjected at a dead brine flow rate of 0.2 cc/min until attaining another steady state coinciding with a breakthrough. It is noteworthy that the second steady state was identified by the stabilization of measured resistance.
d. Started cycle 2 by repeating procedure b with the pure H₂ gas flow rate changed to 0.6 cc/min and then repeating procedure c.
e. Repeated the procedure d for different pure H₂ gas flow rates: 1.2 cc/min (cycle 3), 2.0 cc/min (cycle 4), 5.0 cc/min (cycle 5), and 10.0 cc/min (cycle 6), while keeping the dead brine flow rate constant at 0.2 cc/min.

### Example 8: H₂+Cushion Gas Injection Scenario (Exp 2, 3 and 4)

1. After loading a new core sample based on procedures i to iv, procedure a was repeated while ensuring the Rₒ value falls within a similar range for the global steady state.
2. In Exp 2 (60% H₂-40% CH₄), cycle 1 started following the procedure outlined in procedure b. However, the cushion gas proportion was adjusted by introducing 40% CH₄ gas and 60% H₂ by volume (from accumulator 3) of the estimated injected H₂ pore volume (PV) from Exp 1, before automatically switching to the H₂ valve from accumulator 2 until gas breakthrough.
3. Repeated procedure c for imbibition at 0.2 cc/min.
f. Cycle 2. In a similar manner to procedure d in Exp 1, 40% CH₄ and 60% H₂ by volume of the estimated H₂ pore volume from Exp 1 (at 0.6 cc/min) was injected into the core sample, before automatically switching to H₂ from accumulator 1 until a gas breakthrough was achieved. Subsequently, dead brine (imbibition) was reinjected at a dead brine flow rate of 0.2 cc/min until attaining another steady state coinciding with a breakthrough. It is noteworthy that the second steady state was identified by the stabilization of measured resistance.
4. Repeated procedure d for different (40% CH₄ and 60% H₂) gas flow rates: 1.2 cc/min (cycle 3), 2.0 cc/min (cycle 4), 5.0 cc/min (cycle 5), and 10.0 cc/min (cycle 6), while keeping the dead brine flow rate constant at 0.2 cc/min.
5. Additionally, procedures 1 to 5 were repeated for Exp 3 (60% H₂-40% N₂) where (60% H₂-40% CH₄) was substituted with (60% H₂-40% N₂) and repeated for Exp 4 (60% H₂-40% CO₂) where (60% H₂-40% CH₄) was substituted with (60% H₂-40% CO₂).

### Example 9: Capillary Number

The capillary number (N_{c}) as shown in Eq. (3) plays a role in interpreting and scaling laboratory core flooding experiments. It represents the dimensionless ratio between viscous (N_{c}>>1) and capillary forces (N_{c}<<1). In UHS, higher N_{c} values indicate the dominance of viscosity-driven flow reduces capillary trapping of the nonwetting phase compared to carbon capture and storage (CCS) where lower Ne values indicate capillarity-dominated flow are preferred to improve CO₂ trapping by capillary forces. Hence, with increasing N_{c}, viscous forces prevail over capillary forces, leading to a reduction in capillary trapping of the nonwetting phase. This capillary desaturation associated with increasing Ne is contingent upon the rock type and the type of nonwetting phase, typically occurring within capillary number ranges of 10⁻⁵ to 10⁻⁸,

N_{c}=Qμ/Aγ (3),

where A is the cross-sectional area of the sample (in meter square (m²)), Q is the flow rate (in cubic meters per second (m³/s)), μ is the dynamic viscosity of the gas (in pascal-seconds (Pa·s)), and γ is the brine/gas interfacial tension (in Newton per meter (N/m)). The N_{c} used in this study for the flow rates (using pure H₂ as a reference in Table 2) ranged between 3.98×10⁻⁹ to 1.99×10⁻⁸ based on μ=9.3488 Pa·s and γ=0.069 N/m reflecting a capillary dominated flow regime.

### Example 10: Gas Saturation Profile

Initial (S_{gi}) and residual (S_{gr}) gas saturation profiles were derived from the recorded measurements after either gas breakthrough (drainage) or water breakthrough (imbibition). Initially, the Archie model, depicted in Eq. (4), was applied to determine water saturation (S_{w}) values at different injected pore volumes. Subsequently, S_{g} were derived from these calculated S_{w} values [S_{g}H₂=1−S_{w}] or [S_{g}(H_{2+cushion})=1−S_{w}(H_{2+cushion})], assuming only two fluids system of gas and brine or gas+cushion and brine.

$${S}_{w}^{n} = \frac{Ro}{Rf} \qquad ( 4 )$$

Herein, S_{w} represents the water saturation, Rₒ denotes the 100% water-saturated core samples resistivity (ohms), Rt signifies the true resistivity reading at the experimental condition (ohms), and n stands for the saturation exponent assumed as n=2 for all sedimentary rocks. For each cycle of drainage (with H₂ or H₂+cushion) and imbibition (with 5 wt. % brine), the recovery factor (RF) is calculated using Eq. (5),

RF=(S_{gi}−S_{gr})/S_{gi} (5).

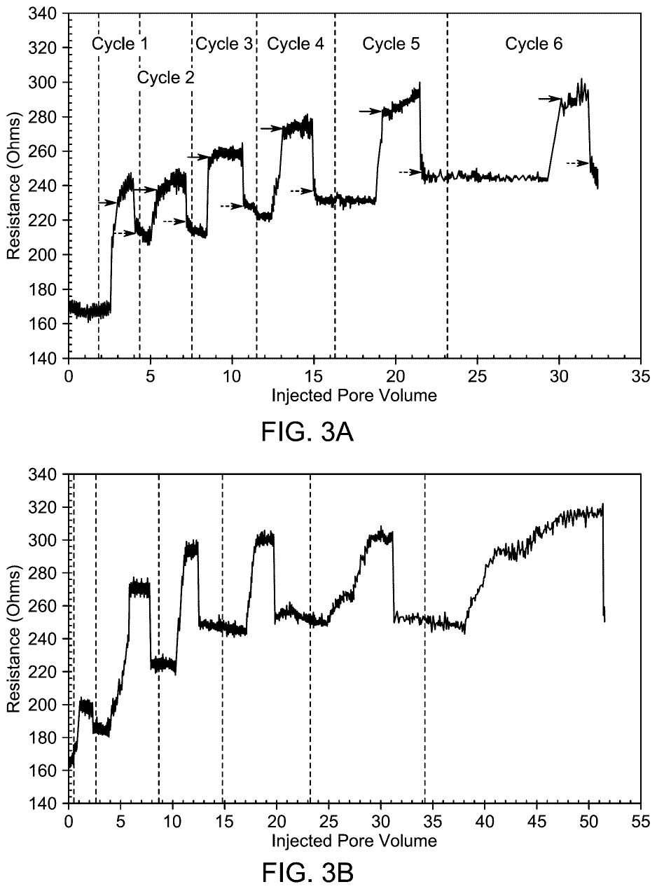

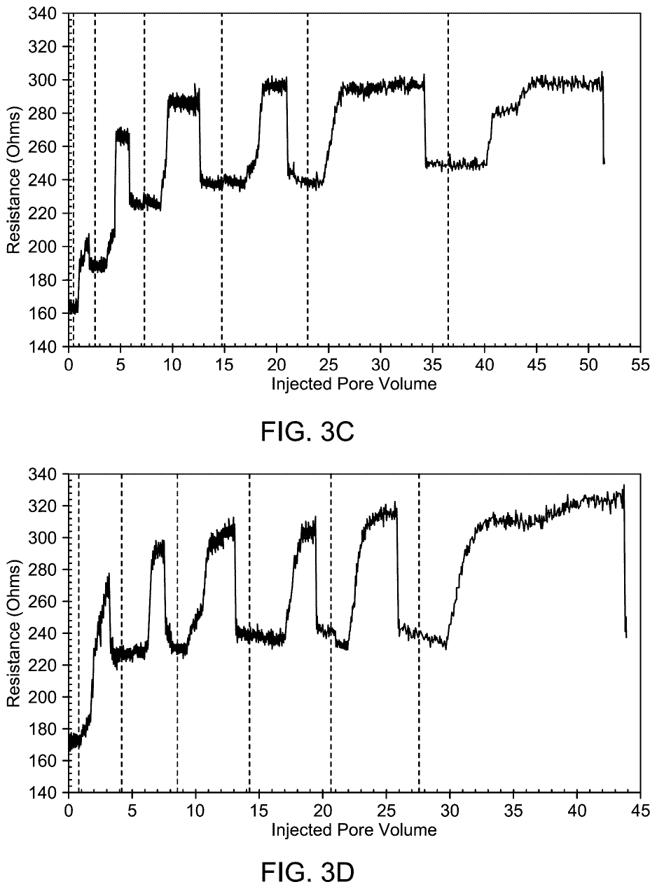

A Bandera Grey (BG) sandstone sample was utilized to illustrate cushion gas type and injection rate impact on S_{gi} and S_{gr} via resistivity core flood. The evolving gas saturations, depicted in FIGS. 3A-3D and Table 2, are charted across various injected PV (calculated as the ratio of cumulative injected fluid volume to the porous medium's PV≈20). FIG. 3A, FIG. 3B, FIG. 3C, and FIG. 3D represent the cases of pure H₂ injection [sample #1], 60% H₂-40% CH₄ [sample #2], 60% H₂-40% N₂ [sample #3] and 60% H₂-40% CO₂ [sample #4], respectively. The vertical lines represent a complete cycle illustrating the continuous gas injection process followed by brine injection. Notably, the core sample was initially fully saturated with 5 wt. % dead brine before starting gas injection, with the same saturating brine used as the chasing fluid. As a basis, the study employed dead 5 wt. % brine (i.e., the brine was not thermodynamically equilibrated with the gas), hence the effect of gas dissolution is not neglected. Also, in Table 2, an average Rₒ=166 ohms for the four independent experiments were used to ensure a uniform baseline is set for comparison before commencing the first cycle (refer to Eq. (4)).

Generally, the measured resistance over the injected pore volume showed a similar trend with increasing gas flow rates from 0.2 cc/min to 10 cc/min since a uniform rate for imbibition was maintained. However, in the case of pure H₂ shown in FIG. 3A, the increment was the least compared to all cushion gas injections preceding H₂, mirroring typical field surface operations for gas storage. Conversely, cushion gas injection scenarios for CH₄ in FIG. 3B, N₂ in FIG. 3C, and CO₂ in FIG. 3D exhibited distinct behaviors. Table 2 illustrates that N₂ exhibited the least measured changes in resistivity after stabilization, followed by CH₄ and CO₂ cushion gases. This trend corresponds to the reactivity of the cushion gases, given that CO₂ is generally more reactive than CH₄, which in turn is more reactive than N₂. Furthermore, as depicted in FIG. 3A-3D, the implementation of continuous cushion gas injection, succeeded by H₂ injection cycles, yielded comparatively higher S_{g} values. This suggests that a greater S_{g} was attained towards the conclusion of the gas injection phase, upon reaching a stable condition, in contrast to the scenario of pure H₂ injection. This higher gas displacement efficiency achieved through continuous cushion and H₂ gas injection led to a higher S_{gr} during the withdrawal (imbibition) process. This is attributed to the improved sweep efficiency of the cushion gas injection compared to H₂ gas.

Table 2. Examples of the experimental conditions and results, including injection rate (Q), measured resistivity (Rt), calculated water saturation (S_{w}), S_{gi} during drainage, residual gas saturation (S_{gr}) during imbibition and the overall RF defined as [(S_{gi}−S_{gr})/S_{gi}] during a single cycle. Note that S_{w} is calculated using saturation exponent, n=2.

| | | | | Drainage | | | Inhibition | | | |
|---|---|---|---|---|---|---|---|---|---|---|
| Core | Gas | Q_{g} | Q_{b} | Rₜ | S_{wi} | S_{gi} | Rₜ | S_{wr} | S_{gr} | RF |
| ID | type | (cc/min) | (cc/min) | (ohms) | (fraction) | (fraction) | (ohms) | (fraction) | (fraction) | (%) |
| #1 | H₂ | 0.2 | 0.2 | 229 | 0.851 | 0.149 | 213 | 0.883 | 0.117 | 21.130 |
| | | 0.6 | 0.2 | 236 | 0.839 | 0.161 | 219 | 0.871 | 0.129 | 19.802 |
| | | 1.2 | 0.2 | 254 | 0.808 | 0.192 | 228 | 0.853 | 0.147 | 23.411 |
| | | 2 | 0.2 | 271 | 0.783 | 0.217 | 236 | 0.839 | 0.161 | 25.779 |
| | | 5 | 0.2 | 283 | 0.766 | 0.234 | 250 | 0.815 | 0.185 | 20.922 |
| | | 10 | 0.2 | 289 | 0.758 | 0.242 | 253 | 0.810 | 0.190 | 21.531 |
| #2 | 60% H₂ − | 0.2 | 0.2 | 202 | 0.907 | 0.093 | 184 | 0.950 | 0.050 | 46.328 |
| | 40% CH₄ | 0.6 | 0.2 | 271 | 0.783 | 0.217 | 222 | 0.865 | 0.135 | 37.760 |
| | | 1.2 | 0.2 | 295 | 0.750 | 0.250 | 250 | 0.815 | 0.185 | 25.903 |
| | | 2 | 0.2 | 303 | 0.740 | 0.260 | 252 | 0.812 | 0.188 | 27.499 |
| | | 5 | 0.2 | 304 | 0.739 | 0.261 | 253 | 0.810 | 0.190 | 27.222 |
| | | 10 | 0.2 | 316 | 0.725 | 0.275 | 260 | 0.799 | 0.201 | 26.979 |
| #3 | 60% H₂ − | 0.2 | 0.2 | 200 | 0.911 | 0.089 | 188 | 0.940 | 0.060 | 32.180 |
| | 40% N₂ | 0.6 | 0.2 | 267 | 0.788 | 0.212 | 226 | 0.857 | 0.143 | 32.407 |
| | | 1.2 | 0.2 | 285 | 0.763 | 0.237 | 239 | 0.833 | 0.167 | 29.650 |
| | | 2 | 0.2 | 292 | 0.754 | 0.246 | 243 | 0.827 | 0.173 | 29.482 |
| | | 5 | 0.2 | 298 | 0.746 | 0.254 | 247 | 0.820 | 0.180 | 28.954 |
| | | 10 | 0.2 | 301 | 0.743 | 0.257 | 252 | 0.812 | 0.188 | 26.807 |
| #4 | 60% H₂ − | 0.2 | 0.2 | 271 | 0.783 | 0.217 | 227 | 0.855 | 0.145 | 33.354 |
| | 40% CO₂ | 0.6 | 0.2 | 292 | 0.754 | 0.246 | 238 | 0.835 | 0.165 | 32.993 |
| | | 1.2 | 0.2 | 300 | 0.744 | 0.256 | 241 | 0.830 | 0.170 | 33.605 |
| | | 2 | 0.2 | 304 | 0.739 | 0.261 | 244 | 0.825 | 0.175 | 32.893 |
| | | 5 | 0.2 | 311 | 0.731 | 0.269 | 245 | 0.823 | 0.177 | 34.351 |
| | | 10 | 0.2 | 321 | 0.719 | 0.281 | 253 | 0.810 | 0.190 | 32.361 |

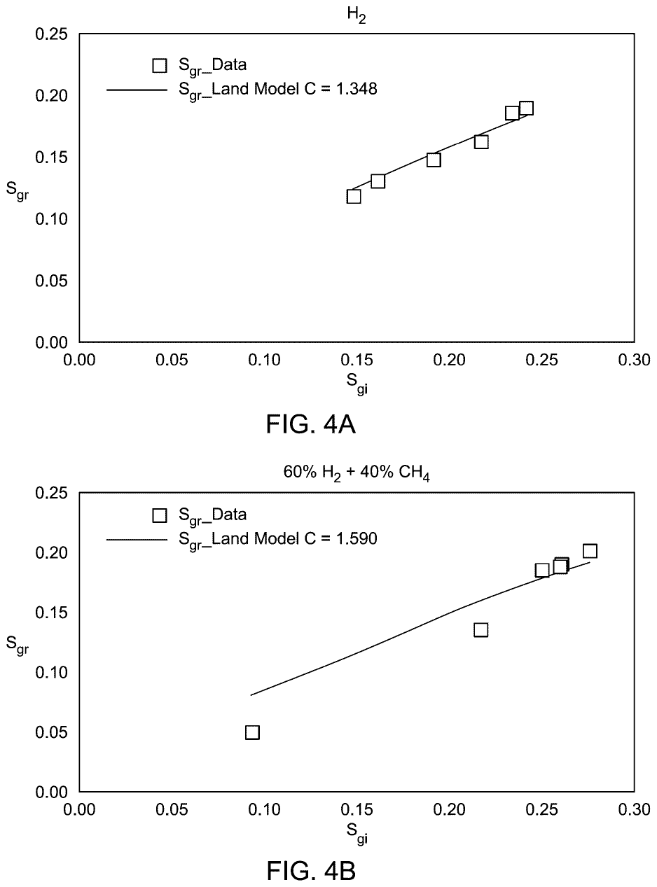

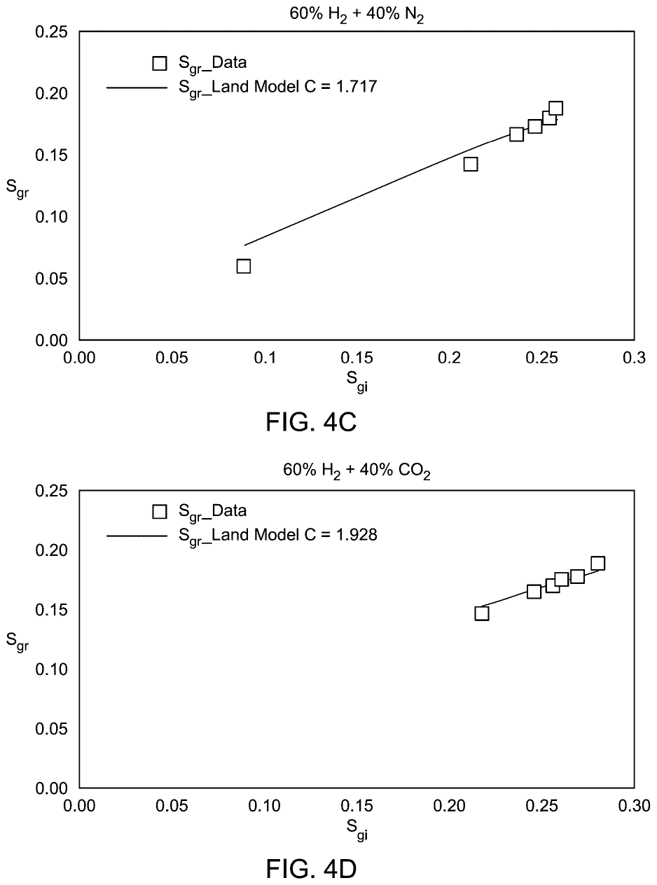

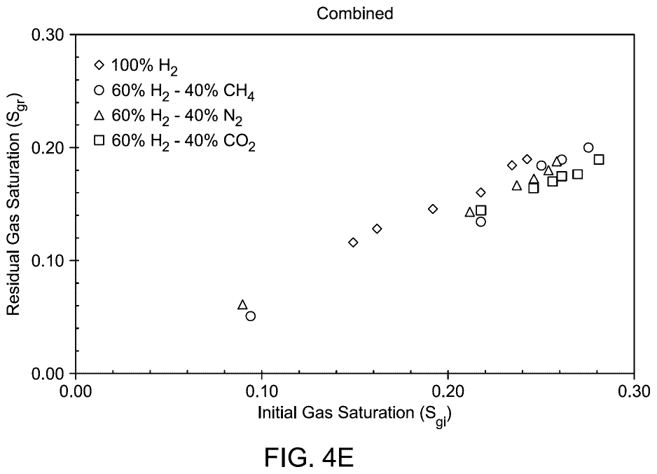

However, S_{gr} may be a complex function of petrophysical factors, including pore structures, porosity, permeability, and fluid interactions at the pore scale. FIGS. 4A-4D are plots for S_{gi} and S_{gr} for Sample #1, Sample #2, Sample #3, and Sample #4, respectively, at 42° C., 1400 psi pressure, and n=2; data is fitted based on Land's model with each showing a different trapping capacity. FIG. 4E is a combined graph of S_{gi} and S_{gr} for all samples. S_{gi} varied for different injection scenarios. Pure H₂ injection resulted in S_{gi} ranging from 14.9% to 24.2%, which is consistent with the literature [Al-Yaseri A, Esteban L, Giwelli A, Sarout J, Lebedev M, Sarmadivaleh M. Initial and residual trapping of hydrogen and nitrogen in Fontainebleau sandstone using nuclear magnetic resonance core flooding. Int J Hydrogen Energy 2022; 47:22482-94, incorporated herein by reference in its entirety. Al-Yaseri A, Esteban L, Yekeen N, Giwelli A, Sarout J, Sarmadivaleh M. The effect of clay on initial and residual saturation of hydrogen in clay-rich sandstone formation: Implications for underground hydrogen storage. Int J Hydrogen Energy 2023; 48:5175-85, incorporated herein by reference in its entirety.], while the addition of 40% CH₄ cushion gas led to an increase, with S_{gi} ranging from 9.3% to 27.5%. Similarly, employing H₂+40% N₂ cushion gas yielded S_{gi} values of 8.9% to 25.7%, and using 40% CO₂ cushion gas before H₂ injection resulted in S_{gi} increasing from 21.7% to 28.1%. During the imbibition phase of cyclic injection with constant withdrawal rates, Ser for pure H₂ rose from 11.7% to 19.0%. For 40% CH₄ cushion gas, S_{gr} increased from 5% to 20.1%, while 40% N₂ cushion gas showed a sequential rise from 6% to 18.8%, compared to 40% CO₂ cushion gas, where S_{gr} increased from 14.5% to 19.0%. The relationship between S_{gi} and S_{gr}, as observed in the resistivity core floods following Archie's model, demonstrates a direct correlation between the two parameters.

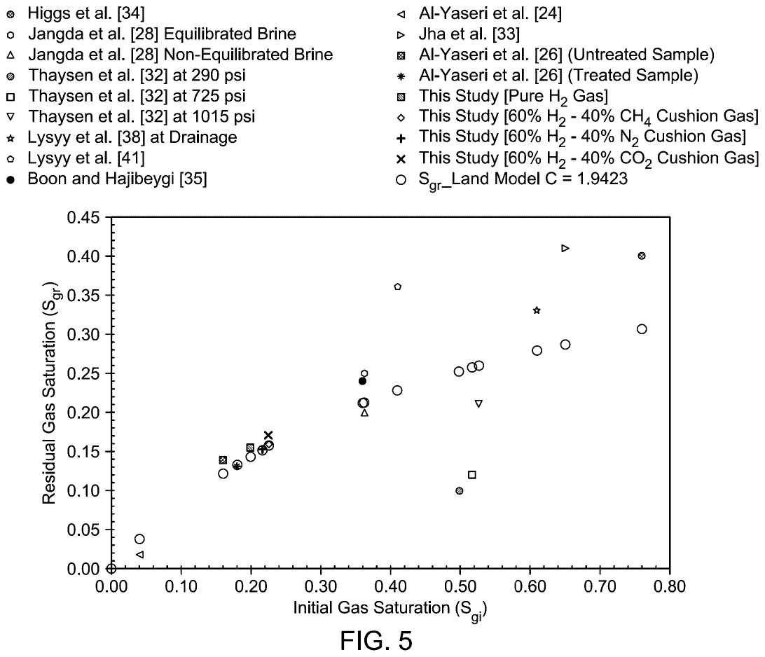

FIGS. 4A-4E indicate that CO₂ is the preferred candidate cushion gas followed by N₂ and CH₄ since a higher Land's coefficient (C) signifies lower trapping efficiency and vice versa. To present a diverse outcome and trend, the result of the current study were plotted with the available literature data (see FIG. 5) based on core flooding, micro CT, and microfluidic experiments following the Land's empirical model [LAND C S. Comparison of calculated with experimental imbibition relative permeability. Soc Pet Eng J 1971; 11:419-25.] to accurately predict the S_{gi} and S_{gr} variations-see Eq. (6),

S_{gr}=S_{gi}/(1+C·S_{gi}) (6).

The empirical constant “C”, known as Land's coefficient, quantifies the trapping capacity of a rock-fluid system. This coefficient ≥0, primarily depends on the properties of the rock and rock-fluid interactions. Therefore, the range of the C coefficient is expected to vary for each reservoir type. However, since the rock samples used in this study are characterized with uniform mineralogy, the C values may range between similar magnitude. For example, pure H₂ injection (C=1.348) exhibited higher trapping capacity which is highly undesirable for H₂ storage and withdrawal. On the other hand, all cushion gasses' C values ranged from 1.590 for 40% CH₄, 1.717 for 40% N₂, and 1.928 for 40% cushion validating the fact that cushion gas injection regardless of the gas type will significantly reduce the gas trapping, hence, reduction of the loss of working gas via snap off is achieved. The results were compared to literature studies as follows: Al-Yaseri A, Esteban L, Giwelli A, Sarout J, Lebedev M, Sarmadivaleh M. Initial and residual trapping of hydrogen and nitrogen in Fontainebleau sandstone using nuclear magnetic resonance core flooding. Int J Hydrogen Energy 2022; 47:22482-94; Al-Yaseri A, Esteban L, Yekeen N, Giwelli A, Sarout J, Sarmadivaleh M. The effect of clay on initial and residual saturation of hydrogen in clay-rich sandstone formation: Implications for underground hydrogen storage. Int J Hydrogen Energy 2023; 48:5175-85; Jangda Z, Menke H, Busch A, Geiger S, Bultreys T, Lewis H, and researchers Pore-scale visualization of hydrogen storage in a sandstone at subsurface pressure and temperature conditions: Trapping, dissolution and wettability. J Colloid Interface Sci 2023; 629:316-25; Thaysen E M, Butler I B, Hassanpouryouzband A, Freitas D, Alvarez-Borges F, Krevor S, and researchers Pore-scale imaging of hydrogen displacement and trapping in porous media. Int J Hydrogen Energy 2023; 48:3091-106; Jha N K, Al-Yaseri A, Ghasemi M, Al-Bayati D, Lebedev M, Sarmadivaleh M. Pore scale investigation of hydrogen injection in sandstone via X-ray micro-tomography. Int J Hydrogen Energy 2021; 46:34822-9; Higgs S, Wang Y Da, Sun C, Ennis-King J, Jackson S J, Armstrong R T, and researchers Direct measurement of hydrogen relative permeability hysteresis for underground hydrogen storage. Int J Hydrogen Energy 2024; 50:524-41; Boon M, Hajibeygi H. Experimental characterization of H 2/water multiphase flow in heterogeneous sandstone rock at the core scale relevant for underground hydrogen storage (UHS). Sci Rep 2022; 12:1-12; Lysyy M, Liu N, Solstad C M, Fernø M A, Ersland G. Microfluidic hydrogen storage capacity and residual trapping during cyclic injections: Implications for underground storage. Int J Hydrogen Energy 2023; 48:31294-304; and Lysyy M, Føyen T, Johannesen E B, Fernø M, Ersland G. Hydrogen Relative Permeability Hysteresis in Underground Storage. Geophys Res Lett 2022; 49.

The degree of variations in reservoir samples can lead to changes in C coefficient values (C=1.9423) due to alterations in pore structure and wettability, even under similar injected fluids and operating conditions. This phenomenon is evident in FIG. 5, where the dispersion in saturation data is attributed to differences in porous materials and methodologies utilized. These include various imaging techniques such as micro and medical CT scans, core flood experiments, and microfluidic methods. However, most of the available data, apart from, originates from either micro-CT or microfluidics studies, with shorter miniature core plugs commonly utilized for H₂ saturation measurements. Furthermore, all studies exclusively injected a single-phased H₂ gas. As such, the precise mechanism behind this deviation remains poorly understood but could be attributed to factors such as pore throat blockage due to fines migration, adhesion of H₂ to grain surfaces, and/or wettability alterations.

The result ideally should reproduce the measured data from this spread, however, the calculation for S_{w} in Eq. (4) is based on a saturation index of n=2 (which when used as n=1, will conveniently reproduce pure H₂ injection cases from FIG. 5), hence the reason behind the lower saturation values. Even at that, the range of values are consistent with those reported by Al-Yaseri and researchers via NMR flooding on BG sandstone [Al-Yaseri A, Esteban L, Yekeen N, Giwelli A, Sarout J, Sarmadivaleh M. The effect of clay on initial and residual saturation of hydrogen in clay-rich sandstone formation: Implications for underground hydrogen storage. Int J Hydrogen Energy 2023; 48:5175-85, incorporated herein by reference in its entirety.] and Fontainebleau sandstone [Al-Yaseri A, Esteban L, Giwelli A, Sarout J, Lebedev M, Sarmadivaleh M. Initial and residual trapping of hydrogen and nitrogen in Fontainebleau sandstone using nuclear magnetic resonance core flooding. Int J Hydrogen Energy 2022; 47:22482-94, incorporated herein by reference in its entirety.], respectively. Thus, given the utilization of sister rock samples [Al-Yaseri A, Esteban L, Yekeen N, Giwelli A, Sarout J, Sarmadivaleh M. The effect of clay on initial and residual saturation of hydrogen in clay-rich sandstone formation: Implications for underground hydrogen storage. Int J Hydrogen Energy 2023; 48:5175-85, incorporated herein by reference in its entirety.], similar behavior in S_{gi} and S_{gr} may exist. However, the variations depicted in both FIG. 5 confirm that the cyclic injection of a cushion gas ahead of the working gas can induce a slight in-situ changes in pore structure based on their reactivity and physicochemical properties.

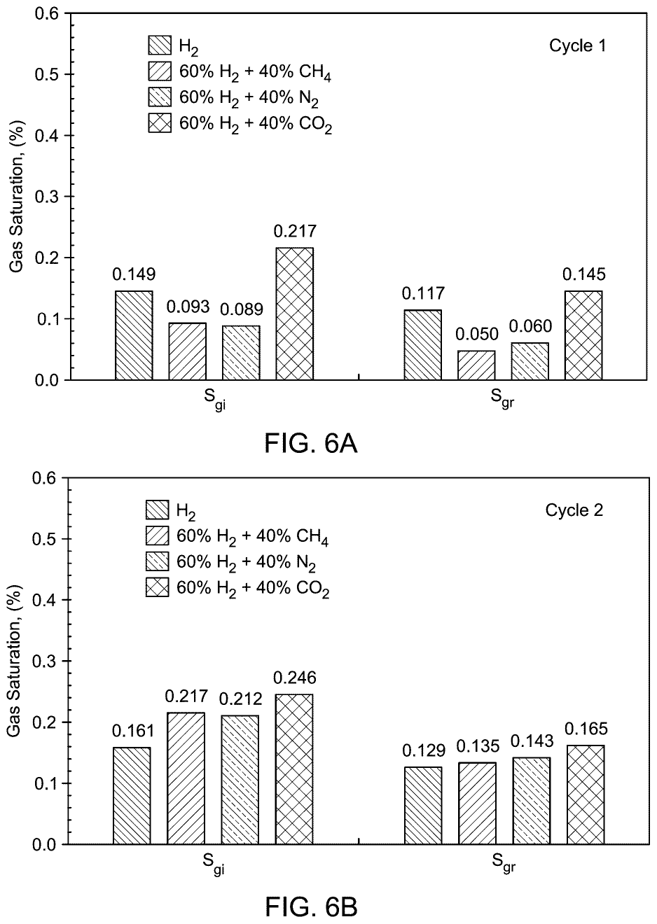

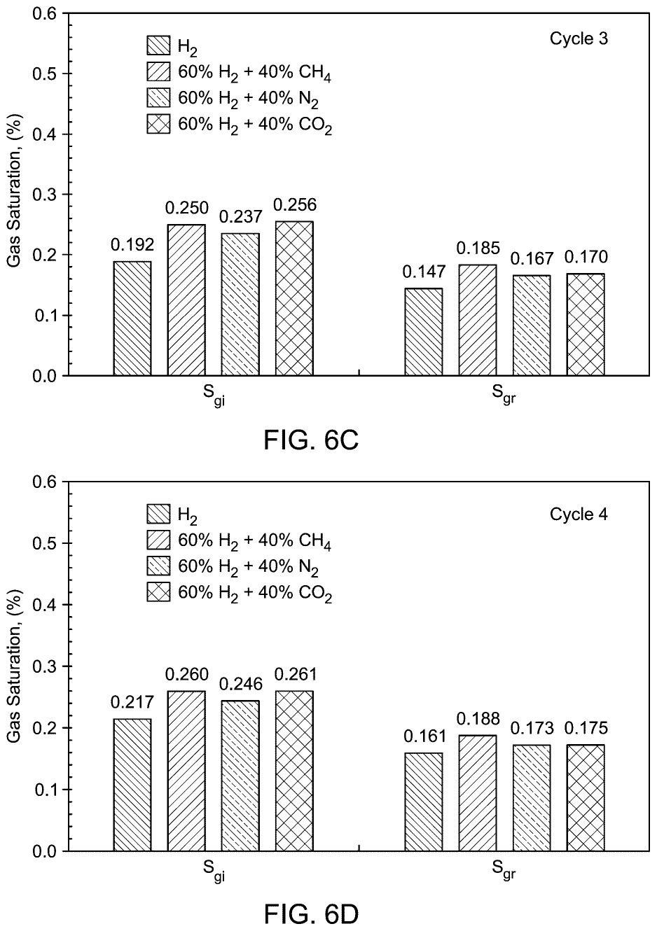

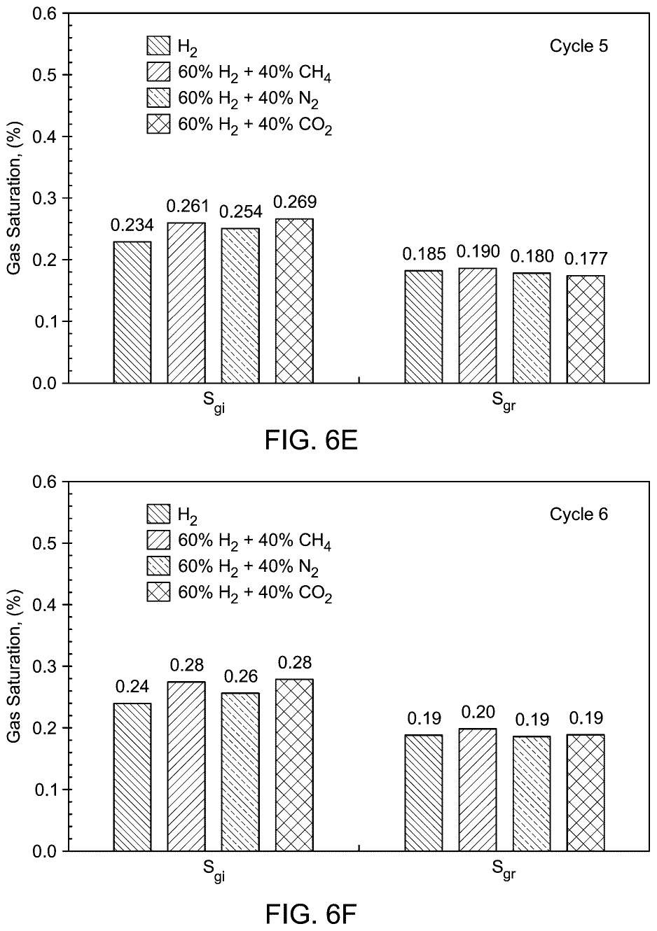

The injection rate can significantly impact the saturation of the storage reservoir. Saturation refers to the fraction of pore space filled with a particular fluid relative to the total pore space available. A higher injection rate can lead to faster displacement of the existing fluid within the reservoir pores by the injected gas leading to higher gas saturation as more pore space is rapidly filled with the injected gas. FIG. 6A-6F shows an effect of injection rate on S_{gi} and S_{gr} for cycle 1 (gas injection rate (Q_{g})=0.2 cubic centimeter per minute (cc/min) and brine injection rate (Q_{b})=0.2 cc/min), cycle 2 (Q_{g}=0.6 cc/min and Q_{b}=0.2 cc/min), cycle 3 (Q_{g}=1.2 cc/min and Q_{b}=0.2 cc/min), cycle 4 (Q_{g}=2 cc/min and Q_{b}=0.2 cc/min), cycle 5 (Q_{g}=5 cc/min and Q_{b}=0.2 cc/min), and cycle 6 (Q_{g}=10 cc/min and Q_{b}=0.2 cc/min) for H₂ and H₂+cushion gas injection. FIGS. 6A-6F show that other than cycle 1, an increase in the gas injection rate from 0.6 cc/min in cycle 2 to 10 cc/min in cycle 6 led to an increase in gas saturation (storage performance). The possible explanation for the case of cycle 1 can be due to the high capillary entry pressure as observed in other studies [Lysyy M, Liu N, Landa-Marbán D, Ersland G, Fernø M. Impact of gas type on microfluidic drainage experiments and pore network modeling relevant for underground hydrogen storage. J Energy Storage 2024; 87, incorporated herein by reference in its entirety., Lysyy M, Liu N, Solstad C M, Fernø M A, Ersland G. Microfluidic hydrogen storage capacity and residual trapping during cyclic injections: Implications for underground storage. Int J Hydrogen Energy 2023; 48:31294-304, incorporated herein by reference in its entirety.]. This also gave rise to the lowest S_{gi} and S_{gr}. The sudden increase in the case of H₂+CO₂ cushion in cycle 1 is majorly due to the fast reaction kinetics of CO₂ cushion gas compared to others. Subsequent cyclic injection however followed a consistent trend of increasing S_{g} with flow rates. This observation is independent of temperature and pressure as the goal was to investigate the effect of increasing gas injection rate at reservoir conditions. However, a recent study by Lysyy and researchers [Lysyy M, Liu N, Landa-Marbán D, Ersland G, Fernø M. Impact of gas type on microfluidic drainage experiments and pore network modeling relevant for underground hydrogen storage. J Energy Storage 2024; 87, incorporated herein by reference in its entirety.] found that pressure had little impact on injection rate as they observed similar gas saturation and flow patterns when their study pressure was increased from 30 bars to 100 bars.

The effect of the injection rate was more pronounced in all the cycles (excluding cycle 1 for CH₄ and N₂), as higher S_{gi} and S_{gr} was observed when compared to the case of injecting only H₂. Lysyy and researchers [Lysyy M, Liu N, Landa-Marbán D, Ersland G, Fernø M. Impact of gas type on microfluidic drainage experiments and pore network modeling relevant for underground hydrogen storage. J Energy Storage 2024; 87, incorporated herein by reference in its entirety.] also based on their cushion gas type study that S_{gi} after drainage can potentially be greater for N₂ and CO₂ than for H₂ due to increasing impacts of pressure on gas properties. While this claim is valid, it is also presented that the injection pattern will also lead to the cushion gas having more S_{gi} compared to the case of injecting only pure H₂.

The findings of Al-Yaseri and researchers [Al-Yaseri A, Esteban L, Giwelli A, Sarout J, Lebedev M, Sarmadivaleh M. Initial and residual trapping of hydrogen and nitrogen in Fontainebleau sandstone using nuclear magnetic resonance core flooding. Int J Hydrogen Energy 2022; 47:22482-94, incorporated herein by reference in its entirety.] also reveal notably lower S_{gi} and S_{gr} for H₂ compared to N₂, irrespective of whether the injection flow rate or Ne were consistent. For instance, under identical injection flow rates, H₂ saturation during primary drainage was 4%, decreasing to <2% after imbibition, while N₂ saturation during primary drainage stood at 26%, reducing to 17% after imbibition. However, when applying the same N_{c} for the N₂ experiment as that of H₂, N₂ saturation values were approximately 15% for S_{gi} and 8% for S_{gr}. These results offer promising support for UHS.

The injection rate for gas storage is a parameter directly impacting the efficiency and effectiveness of gas recovery from subsurface reservoirs. Controlled injection rates are essential for maintaining reservoir pressure, improving production rates, and enhancing recovery efficiency. Additionally, it influences sweep efficiency by promoting better fluid displacement and more thorough reservoir sweep, ultimately enhancing gas recovery outcomes. However, injection rates that are too high can lead to issues such as premature gas breakthrough, and uneven reservoir depletion.

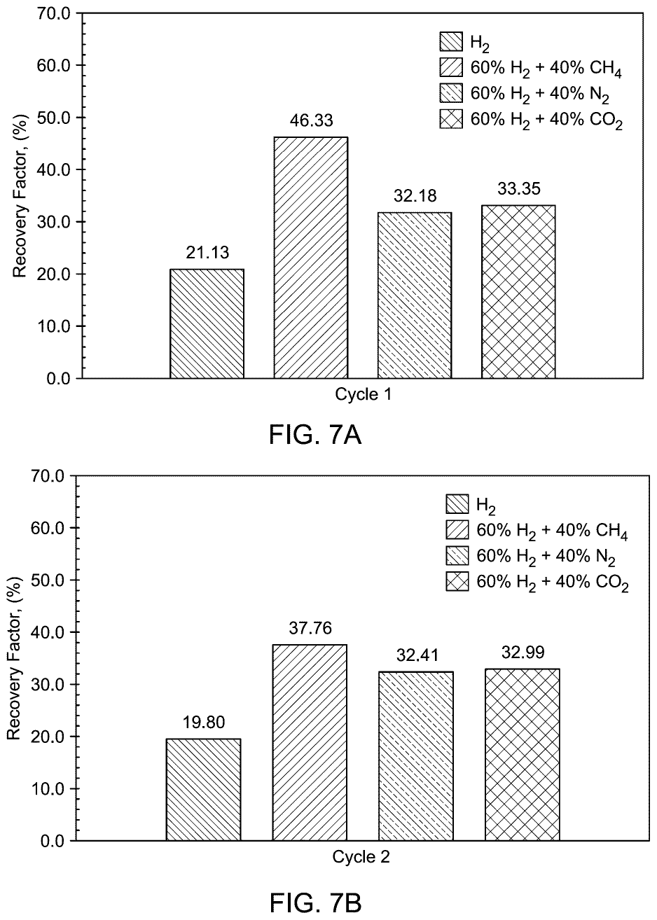

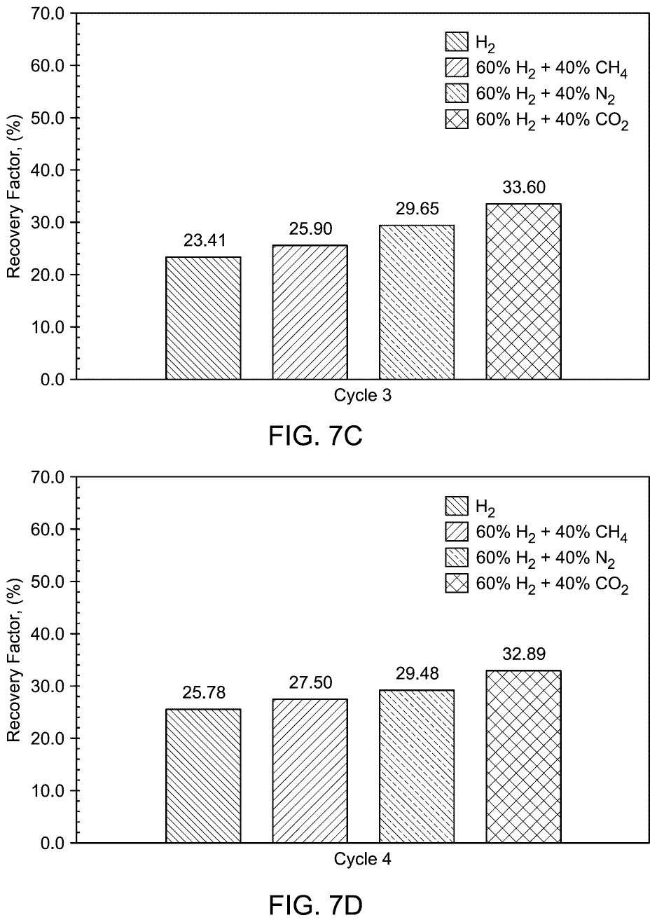

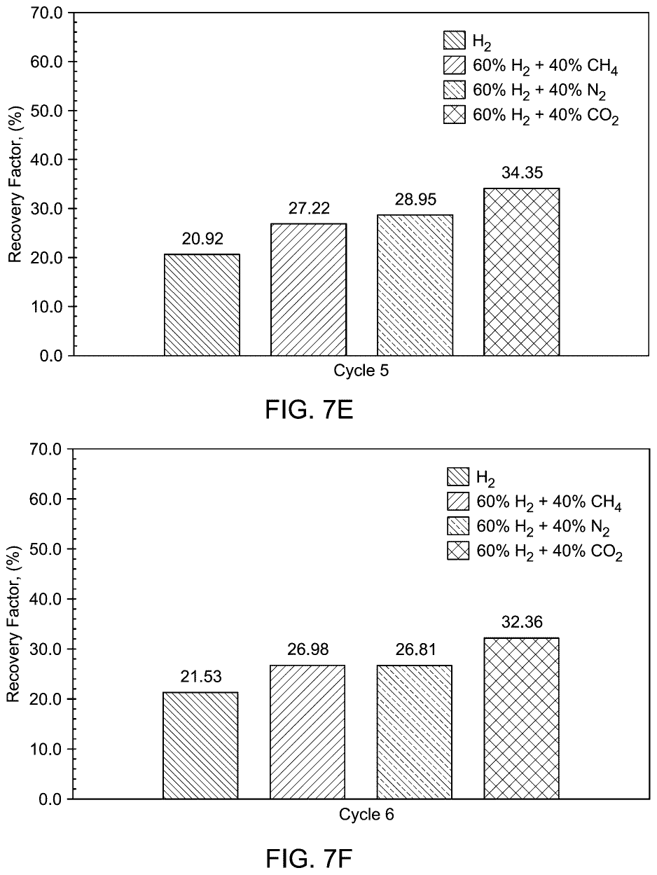

FIGS. 7A-7F show an effect of injection rate on gas recovery for cycle 1-cycle 6, respectively, for H₂ and H₂+cushion gas injection. FIGS. 7A-7F illustrate that the recovery of the working gas increases with injection rate across all experimental conditions. Specifically, scenarios involving cushion gas all demonstrated higher withdrawal fractions, with CO₂ exhibiting the highest, followed by N₂ and CH₄ compared to pure H₂ injection. However, it was noticed that at a gas injection rate of 0.2 cc/min (cycle 1) and 0.6 cc/min (cycle 2), CH₄ cushion gas exhibited the highest recovery compared to CO₂ and N₂. Similarly, at a gas injection rate of 1.2 cc/min (cycle 3) to 10 cc/min (cycle 6), using CO₂ cushion gas will result in higher recovery than CH₄ and N₂. Though at 10 cc/min (cycle 6), using CH₄ gas will result in high gas recovery (26.98%) compared to N₂ (26.81%). Overall, it can be said that within the core samples, the macroscopic recovery fraction fluctuates between cycles, in line with the microscopic RFs recently investigated by Lysyy and researchers [Lysyy M, Liu N, Solstad C M, Fernø M A, Ersland G. Microfluidic hydrogen storage capacity and residual trapping during cyclic injections: Implications for underground storage. Int J Hydrogen Energy 2023; 48:31294-304.]. However, injecting CH₄ cushion gas based on the result will be more beneficial for higher gas withdrawal at a lower injection rate (0.2 and 0.6 cc/min) whereas CO₂ is recommended for a higher injection rate (between 1.2 to 10 cc/min).

The investigated RFs for pure H₂ range from 19% to 25%, with CH₄ cushion gas showing a range of 25% to 46%, N₂ cushion gas ranging from 26% to 32%, and CO₂ cushion gas ranging from 32% to 33%, averaging around 34%. This average is comparable to RFs reported from reservoir simulations of H₂ storage in the H₂O zone of a depleted hydrocarbon field (49%) and aquifer storage (36-59%). Additionally, RFs derived from reservoir simulations offer a macroscopic perspective applicable to the entire reservoir.

The NMR relaxation time, T2, characterizes the duration for the decline of net proton magnetization within fluid confined in porous rock and correlates directly with pore size. In simpler terms, smaller pores demonstrate shorter T2 values, whereas larger pores exhibit longer T2 values. Given that each pore size corresponds to a unique relaxation time, directly linked to its size, it is possible to ascertain the pore size distribution of the fluids from the T2 relaxation time. Pores are categorized based on their NMR T2 relaxation times: vugs have T2 values exceeding 1000 milliseconds (ms), macropores and mesopores range between 10 and 1000 ms, and 1 and 10 ms, respectively, while micropores have T2 values below 1 ms.

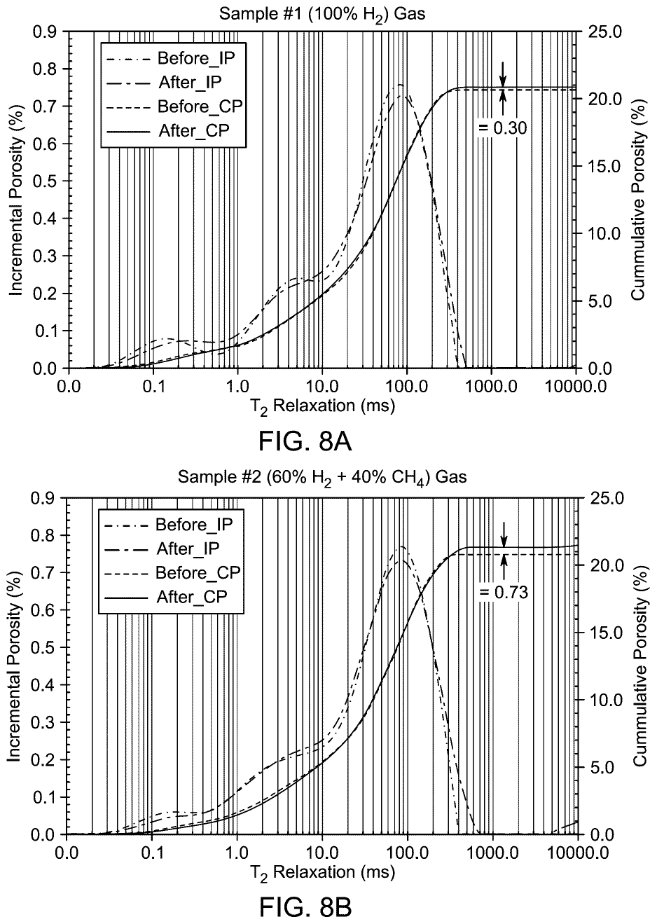

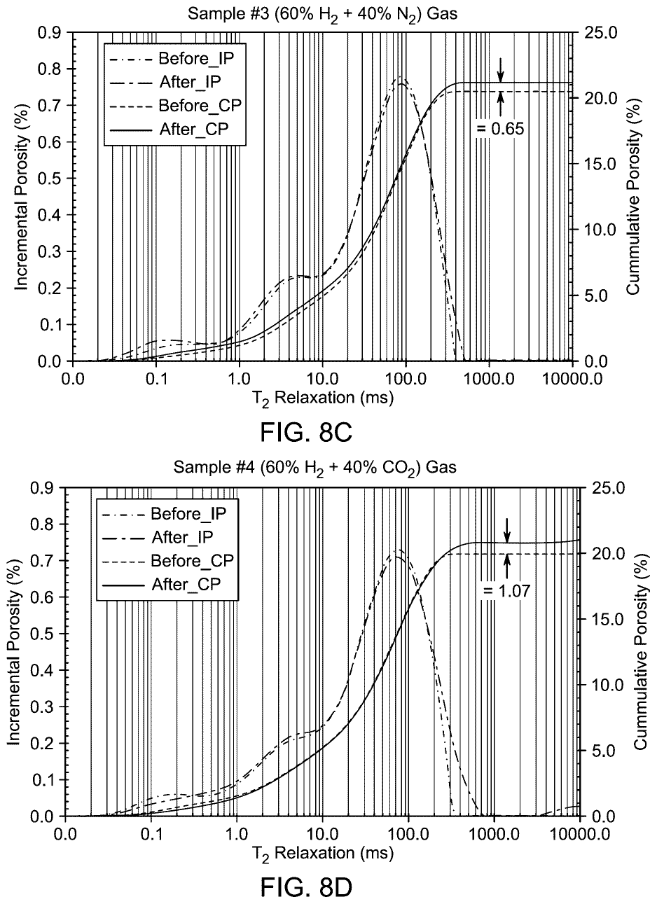

The NMR measurement before flooding revealed the presence of macro, meso, and micropores with various sizes and distributions across the BG samples from FIGS. 8A-8D. Post-flooding also reveals a noticeable degree of consistency in peaks. This phenomenon shows that the fluid must have maintained a uniform flow pattern in the pores space during injection (see also FIG. 3A-3D for the multiple cyclicities). The insignificant difference in terms of the peaks is solely attributed to the gas type. For example, H₂ gas in FIG. 8A only increased by 0.30 porosity compared to N₂ in FIG. 8C which increased only by 0.65. FIG. 8B for CH₄ and FIG. 8D for CO₂ cushion gas exhibited significant increases (i.e., 0.73 and 1.07) supported by the high degree of reactiveness of this gas with the grain particles compared to H₂ and N₂. This observed increase in porosity occurred from carbonate mineral dissolution such as dolomite [CaMg(CO₃)₂] present in the BG sandstone (see XRD result of Table 1). To further confirm these changes, an ion chromatograph of the produced effluents was conducted. From the observed cations, Mg²⁺ and Ca²⁺ concentration were the highest in sample #4, followed by sample #2, then sample #3 and finally sample #1. Ammonium (NH₄⁺) was only identified in sample #3 which was due to the presence of N₂ gas. The variation in Na⁺ and K⁺ stems from the different clay-rich minerals.

TABLE 3
Ion chromatography result of the produced effluents

| Core | | | | | | | |
|---|---|---|---|---|---|---|---|
| samples | Gas | Na⁺ | K⁺ | Mg²⁺ | Ca²⁺ | Li⁺ | NH₄⁺ |
| ID | designation | (ppm) | (ppm) | (ppm) | (ppm) | (ppm) | (ppm) |
| #1 | 100% H₂ | 16236.38 | 40.515 | 100.077 | 722.816 | ND | ND* |
| #2 | 60% H₂ + 40% CH₄ | 21061.23 | 25.165 | 108.632 | 728.226 | ND | ND* |
| #3 | 60% H₂ + 40% N₂ | 18318.52 | 28.647 | 104.487 | 700.248 | 2.961 | 3996.917 |
| #4 | 60% H₂ + 40% CO₂ | 20359.38 | 31.781 | 126.568 | 782.835 | ND | ND* |

*ND = Not Determined.

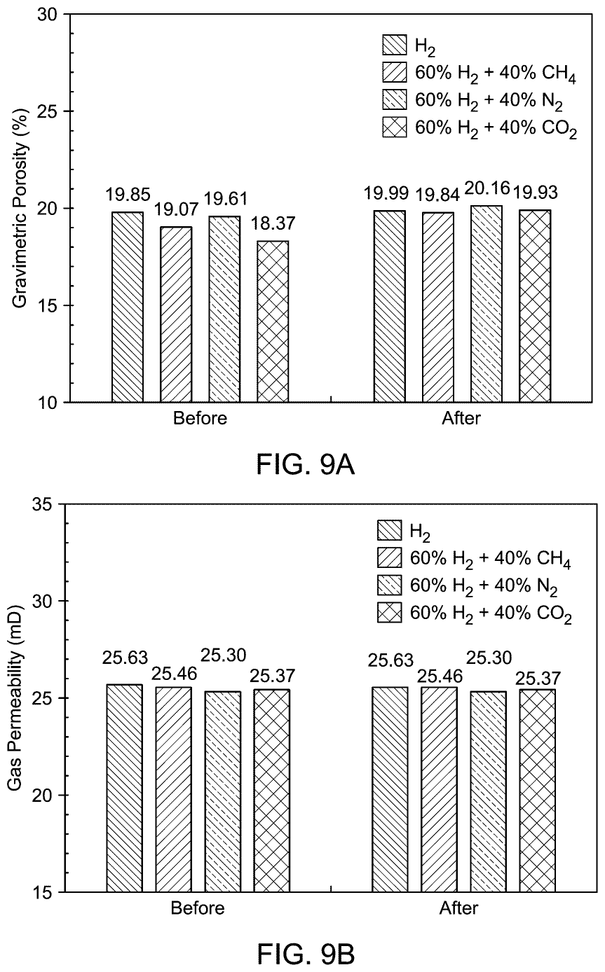

The gravimetric porosity and N₂ permeability experimental measurements before and after of the core samples are depicted in FIGS. 9A-9B, respectively. As previously mentioned, two types of porosity measurements were performed, including NMR and gravimetric to assess variations in the pore space. The mean gravimetric porosity of the core samples is 19.97%+0.25%, based on the following sample data: Sample #1 (100% H₂) has a porosity of 19.85%, Sample #2 (60% H₂+40% CH₄) has 19.07%, Sample #3 (60% H₂+40% N₂) has 19.61%, and Sample #4 (60% H₂+40% CO₂) has 18.37%. The values exhibit slight variations across different gas mixtures, but the mean porosity remains consistent with a relatively narrow error range. Similar to the observations depicted in FIGS. 8A-8D via NMR, FIG. 9A for gravimetric porosity exhibited a similar trend. Table 4 is a summary of the porosity and permeability properties of the sister samples after flooding. In sample #1 for H₂, the porosity increased by plus 0.14% (from 19.85% to 19.99%), followed by sample #3 for N₂ with only a 0.55% increase (from 19.61% to 20.16%). Sample #2 for CH₄ followed next with a 0.78% plus increase (from 19.07% to 19.84%), and finally, sample #4 for CO₂ cushion gas increased by only 1.56% (from 18.37% to 19.93%). Despite variations, the results from different porosity analyses are consistent, displaying a positive trend of increasing porosity with the geochemical reactiveness of the injected gases.

The results from N₂ gas permeability measurements in FIG. 9B, however, did not show any significant changes in post-permeability measurement. This is likely to be a function of the primary dissolution and immediate precipitation within the pore space that may have occurred, thus, both effects cancel out based on the mineral composition of the BG sandstone samples. This suggests that pore-blocking clay minerals such as illite and kaolinite may have facilitated greater precipitation during gas drainage (both cushion and subsequently H₂), balancing out the dissolution rate of minerals like dolomite. This aligns with the consistent pore size and distribution observed in the NMR plot (FIG. 8). Furthermore, it corroborates the persistence of multiple injection drainage cycles shown earlier in FIG. 3, where increased pore space became available for gas storage during continuous injection, particularly with CO₂ resulting in higher pore fluid content, leading to higher resistivity and consequently higher S_{gi}.

TABLE 4
Porosity and permeability properties of the sister samples after flooding.

| | | | | Dry | Saturated | Gravimetric | NMR | N₂ Gas |
|---|---|---|---|---|---|---|---|---|
| Core | Gas | Length | Diameter | weight | weight | porosity | porosity | Permeability |
| sample | designation | (mm) | (mm) | (g) | (g) | (%) | (%) | (mD) |
| #1 | 100% H₂ | 93.63 | 37.93 | 227.29 | 248.97 | 19.99 | 20.90 | 25.631 |
| #2 | 60% H₂ + | 94.58 | 37.93 | 228.58 | 250.51 | 19.84 | 21.60 | 25.458 |
| | 40% CH₄ | | | | | | | |
| #3 | 60% H₂ + | 93.74 | 37.93 | 226.91 | 248.99 | 20.16 | 21.20 | 25.301 |
| | 40% N₂ | | | | | | | |
| #4 | 60% H₂ + | 93.20 | 37.93 | 221.53 | 243.42 | 19.93 | 21.03 | 25.369 |
| | 40% CO₂ | | | | | | | |

Herein, the geological storage of H₂ stands as a promising technique for realizing a sustainable future. Its efficacy, however, depends on various trapping mechanisms that immobilize the injected H₂. Residual trapping, among these mechanisms, has been identified as a factor, presenting a risk of H₂ loss. Hence, the injection of a cushion gas is imperative for de-risking H₂ loss. This study presents a resistivity core flooding experiment designed to quantify the impact of cushion gas type and injection rate on storage and recovery performance, as well as fluid distribution within rock pores. Bandera Grey sandstone plugs were utilized under storage conditions of 42° C. and 1400 psi, with a 5 wt. % NaCl brine solution. On average, the injection of CO₂ as a cushion gas prior to the working gas yielded the highest storage capacity, with a value of 25.5%. This was followed by CH₄, which had a storage capacity of 22.6%, while N₂ gas exhibited the lowest storage capacity at 21.6%.

Averagely, the highest gas recovery was observed with CO₂ cushion gas at 33.26%, compared to CH₄ at 31.95% and N₂ cushion gas at 29.92%. However, at lower injection rates (0.2 to 0.6 cc/min), CH₄ cushion gas demonstrated the highest recovery of 42.0%, while CO₂ performed better at higher injection rates (1.2 to 10 cc/min) with a RF of 33%. NMR porosity analysis indicated a consistent trimodal pore size distribution (macropores, mesopores, and micropores) both before and after flooding with the tested cushion gases. Additionally, NMR porosity increased post-flooding, with CO₂ cushion gas exhibiting the highest porosity (1.07), followed by CH₄ (0.73) and N₂ (0.65), which was consistent with gravimetric porosity measurements. However, permeability remained unchanged.

Numerous modifications and variations of the present disclosure are possible in light of the above teachings. It is therefore to be understood that within the scope of the appended claims, the invention may be practiced otherwise than as specifically described herein.

1. A method of hydrogen (H₂) storage and withdrawal, the method comprising:
executing a first cycle of low-speed storage and withdrawal, comprising
injecting a first cushion gas into a subsurface formation comprising sandstone rock via an injection well at a first speed of 0.2-0.6 cubic per minute (cc/min)/225 grams (g) sandstone rock, the first cushion gas comprising 30-50 volume percent (vol. %) of methane (CH₄) and 50-70 vol. % of H₂ based on a total volume of the first cushion gas, wherein a weight of the sandstone rock is a dry weight,
injecting a first working gas into the subsurface formation at a second speed of 0.2-0.6 cc/min/225 g sandstone rock to store H₂ in the subsurface formation and obtain a first breakthrough, the first working gas comprising 70-100 vol. % of H₂ based on a total volume of the first working gas, and
injecting a first brine solution into the subsurface formation at a third speed of 0.1-0.3 cc/min/225 g sandstone rock to withdraw at least a portion of the H₂ from subsurface formation via a production well and obtain a second breakthrough; and
executing a second cycle of high-speed storage and withdrawal, comprising
injecting a second cushion gas into the subsurface formation at a fourth speed of 1.2-10 cc/min/225 g sandstone rock, the second cushion gas comprising 30-50 vol. % of carbon dioxide (CO₂) and 50-70 vol. % of H₂ based on a total volume of the second cushion gas,
injecting a second working gas into the subsurface formation at a fifth speed of 1.2-10 cc/min/225 g sandstone rock to store more H₂ in the subsurface formation and obtain a third breakthrough, the second working gas comprising 70-100 vol. % of H₂ based on a total volume of the second working gas, and
injecting a second brine solution into the subsurface formation at a sixth speed of 0.1-0.3 cc/min/225 g sandstone rock to withdraw at least another portion of the H₂ from subsurface formation via the production well and obtain a fourth breakthrough.

2. The method of claim 1, wherein:
the first cushion gas comprises about 40 vol. % of CH₄ and about 60 vol. % of H₂ based on the total volume of the first cushion gas.

3. The method of claim 2, wherein:
a H₂ recovery factor (RF) of the first cycle is 37.76 to 46.33.

4. The method of claim 1, wherein:
the second cushion gas comprises about 40 vol. % of CO₂ and about 60 vol. % of H₂ based on the total volume of the second cushion gas.

5. The method of claim 4, wherein:
a H₂ RF of the second cycle is 32.36 to 34.35.

6. The method of claim 1, wherein:
the first cushion gas does not include CO₂.

7. The method of claim 1, wherein:
the second cushion gas does not include CH₄.

8. The method of claim 1, wherein the sandstone rock comprises, based on the weight of the sandstone rock:
50-75 weight percent (wt. %) of quartz;
5-15 wt. % of dolomite;
10-20 wt. % of albite;
0-1 wt. % of anorthoclase;
5-15 wt. % of illite; and
1-9 wt. % of kaolinite.

9. The method of claim 1, wherein the sandstone rock comprises, based on the weight of the sandstone rock:
63.5 wt. % of quartz;
8.6 wt. % of dolomite;
14.7 wt. % of albite;
0.2 wt. % of anorthoclase;
8.5 wt. % of illite; and
4.2 wt. % of kaolinite.

10. The method of claim 9, wherein:
the sandstone rock has a porosity of 18-20% and a nitrogen (N₂) gas permeability of 25-26 millidarcy (mD).

11. The method of claim 1, further comprising:
injecting an initial brine solution into the subsurface formation at an initial speed of 0.1-0.3 cc/min/225 g sandstone rock, before the executing the first cycle.

12. The method of claim 1, wherein:
the first working gas comprises 95-100 vol. % of H₂ based on the total volume of the first working gas, and
the second working gas comprises 95-100 vol. % of H₂ based on the total volume of the second working gas.

13. The method of claim 1, wherein:
the first speed and the second speed are identical, and
the fourth speed and the fifth speed are identical.

14. The method of claim 1, wherein:
the third speed is about 0.2 cc/min/225 g sandstone rock, and
the sixth speed is about 0.2 cc/min/225 g sandstone rock.

15. The method of claim 1, wherein:
the first brine solution comprises 1-10 wt. % of sodium chloride (NaCl) based on a total weight of the first brine solution, and
the second brine solution comprises 1-10 wt. % of NaCl based on a total weight of the second brine solution.

16. The method of claim 1, wherein:
the first brine solution comprises about 5 wt. % of NaCl based on the total weight of the first brine solution, and
the second brine solution comprises about 5 wt. % of NaCl based on the total weight of the second brine solution.

17. The method of claim 1, further comprising:
measuring an electrical resistivity of the subsurface formation during the first cycle and the second cycle; and
determining a corresponding breaking when the electrical resistivity is stable.

18. The method of claim 1, wherein:
the first cycle is executed before the second cycle.

19. The method of claim 18, wherein in the first cycle:
the first cushion gas is injected before the first working gas is injected, and
the first working gas is injected before the first brine solution is injected.

20. The method of claim 18, wherein in the second cycle:
the second cushion gas is injected before the second working gas is injected, and the second working gas is injected before the second brine solution is injected.
